(19) United States
(12) Patent Application Publication
(10) Pub. No.: US 2018/0330756 A1
(43) Pub. Date: Nov. 15, 2018

(54) METHOD AND APPARATUS FOR CREATING AND AUTOMATING NEW VIDEO WORKS

(71) Applicant: James MacDonald, Los Angeles, CA (US)

(72) Inventor: James MacDonald, Los Angeles, CA (US)

(21) Appl. No.: 15/818,453

(22) Filed: Nov. 20, 2017

Related U.S. Application Data
(60) Provisional application No. 62/424,408, filed on Nov. 19, 2016.

(51) Int. Cl. G11B 27/036; G06F 17/30

(52) U.S. Cl. CPC G11B 27/036; G06F 3/0484; G06F 17/30825; G06F 17/30864

(57) ABSTRACT

The present invention relates to a method of allowing users to insert themselves into movie clips, full movies, animations, music videos, commercials, sporting events and other videos. The method and computer apparatus, made up of one or more computer devices interconnected through the internet or network, allows the editing of existing videos by the creation of machine software code instruction templates to automate the editing of those videos, the method of allowing of users to record and edit their takes on those scenes and then insert their takes into the existing video using the automated template instructions that then automate the rendering of the new video composition. The present invention allows for the mass production of the new compositions to be streamed or shared as a custom video. The present invention also allows for the digital rights management of the original video and the newly created video, through the database structure and through metadata tags inserted into the new composite videos with the incorporation of a hierarchical database structure into a communications network of data processing devices so that metadata can be communicated between them.

### BACKGROUND OF THE INVENTION

### Field of the Invention

Everyone wants to be a star. Now they can be. This invention allows millions of people to star in famous movie clips and full movies as well as popular music videos, animated videos, television shows, sports events, commercials and just about any other videos. This invention automates the video editing process, dramatically reducing the editing times, editing complexity, and overall computer processing, by creating a shared video editing software platform, thereby allowing a user or groups of users to become part of the movie and television industry and collaborate by customizing film clips and customizing entire movies using their cell phones or other computer devices connected to the internet and a server and then sharing the final output over streaming video channels back through the internet to connected devices, including phones, computers and television sets and through social media sites. This invention creates a new device allowing a new genre of customized movies and videos, that allows the fan base to customize their favorite movies and videos, by replacing scenes, actors, dialog and sound, and allowing for the selection and modification of films, television shows, music videos, animations, commercials, sporting events and other popular clips. This invention creates a new market and method of selling movie clips and managing the digital rights of the new composition. This invention creates a new market and method of advertising movie clips. This method and computer apparatus dramatically reduces computer and human processing times, and makes the chore of video editing into a fun game like experience.

The present invention is in the technical field of video and audio editing. The present invention allows for the creation of a new system of computer hardware and interconnected devices to automatically digitally process video and audio files and output that video product as a video streaming service or digital image file. More particularly, the present invention in the preferred embodiment, is in the technical field of video and audio editing on portable devices, such as mobile phones or tablets, using hardware integrated into the mobile phones, including video recorders and sound recorders, with connectivity to the internet and cloud hardware, integrated with a database schema and metadata. The present invention also allows for the digital rights management of the original video and the newly created video, through the database structure and through metadata tags inserted into the new composite videos with the incorporation of a hierarchical database structure and metadata into a communications network of data processing devices so that metadata can be communicated between them.

### Background

Software and equipment for editing video has been around for decades and video editors exist from simple to complex to meet the market demand for various user skill levels. However, despite advances making video editing easier, it is still extremely cumbersome and requires significant computer resources, including time spent on the computer device to learn the video editing software, time to record new video sequences and then edit them, time to manage video files, audio files and image files on the timeline which can number in the hundreds for a single composition, time spent adding the precise placement of new clips, to process the new clips with crop, cutting, position, color, zoom, rotate, and other special effects settings for each video clip within the timeline editor, rendering the new composition, saving the new composition, uploading and sharing the new composition. Additional user time can be spent to acquire any rights to use the video clips, and negotiate the rights to broadcast the clips, and then share and broadcast those clips, and monetize those clips. It also requires significant technical skill, time, effort, and creativity to develop new sequences and edits to existing videos so that the new composition is fun to watch. For the average person, to edit a Hollywood blockbuster, and insert themselves into a scene, as well as the other complicated steps of digital rights management is almost impossible to Figure out how to do it. The average user does not have the skills or time necessary to audition, screen test, sing along, parody or comment on a popular video or otherwise use that video under the Fair Use doctrine or under license from rights holders. The existing art does not come close to making this possible, until this invention.

The present invention relates to a set of methods and an apparatus to allow one or more users to insert themselves into original video works, thus creating a modified video work. The method allows the editing of original video works through the use of machine software code instruction templates as part of the present invention to automate the editing of those videos.

The prior art heretofore required a user in creating a modified video work to manually create a combined work. This required an intermediate to expert level of understanding of video editing in order to create a professional end result. U.S. Pat. No. 9,117,483 is an example of such prior art requiring a user to manually create a new video work, and thus requiring a user to have a sufficient level of skill. The present invention gives users with no experience in video editing the ability to make professionally done videos.

As used herein, the term “mashup” refers to taking 2 or more original videos into one large video.

The term “button” refers to a small digital icon or image that, when touched, carries out an action in the digital aspect.

The term “cloud” refers to physical servers that store data over the Internet remotely. The term audio lines refer to the auditory aspect of a video.

The term “take” or “takes” refers to a visual and audio recording based on a scene of an original video work.

The term “clip” refers to a short video recording.

The term “scene” refers to the actual original recording from a movie.

The term “original video work” refers to the non-manipulated form of a video work, non-manipulated meaning a true copy of the end product of the video work, as determined by the creator.

The term “digital rights” refer to the relationship between registered or non-registered digital works and owner permission related to modifying digital works on computers, networks, and electronic devices.

The term “metadata” refers to information about a work, such as a digital video work including when, how and by whom the digital video work was created and, when modified, who modified the work, dates of modification, file type and other technical information, who can access digital video work, title, abstract, author, keywords, ownership and the like or may include links back to a central database that contain may include non-public data about ownership and revenue splits from viewing the work.

The phrase “portable digital storage device” refers to portage storage such as compact disc (CD), digital video disk (DVD), remote storage, and mobile device storage such as smart phone, tablet, laptop, game console, augmented reality head set, home computer storage,

### SPECIFICATION

The present invention relates to a method of allowing users to insert themselves into movie clips, full movies, animations, music videos, commercials, sporting events and other videos. The method and computer apparatus, made up of one or more computer devices FIG. 1 interconnected through the internet or network 103, allows the editing of existing videos by the creation of machine software code instruction templates FIG. 8, FIG. 9A, FIG. 9B, FIG. 9C, FIG. 11 and FIG. 12 to automate the editing of those videos, the method of allowing of users to record and edit their takes on those scenes FIG. 6 and then insert their takes into the existing video using the automated template instructions that then automate the rendering of the new video composition FIG. 11, FIG. 12, and FIG. 19. The present invention allows for the mass production of the new compositions to be streamed or shared as a custom video. The present invention also allows for the digital rights management of the original video 1401 and the newly created video 1405, through the database structure and through metadata tags 1406 inserted into the new composite videos with the incorporation of a hierarchical database structure 1001 into a communications network 1309 of data processing devices 1310 and 1311 so that metadata can be communicated between them.

This invention allows unskilled users FIG. 13 to insert themselves into videos without all the complicated video editing steps in a traditional timeline and multi-track video editing software and without requiring a user to learn a complicated video multitrack editor interface, by having skilled video editors or coders create automated sequences of instructions FIG. 11 and FIG. 12 for a particular video and making these templates together with the original videos seamlessly available to the unskilled user FIG. 4A-FIG. 4B through the novel data structure of the computer system, an example shown in FIG. 10 and interconnected devices with lens and video and audio capture cards FIG. 13 and set of image processing instructions FIG. 11 and FIG. 13 and metadata information FIG. 14 as described in the present invention.

A user is allowed to insert themselves into video works by having the user:
(1) select the roles 406 and audio lines 506 and 513, known collectively as a “take” or “takes” that he wants to play;
(2) record one or more of his takes 515,
(3) select from the set of takes the favorite one for processing for each line 604;
(4) have additional users join the edit room to play other roles in the scene 524 and 525 who repeat steps (1) through (3) and
(5) click render “one-touch 520 to be in the original video work, modified with the user(s) take(s).

Advantages of the present invention include a breakthrough in managing and automating the workflow of the traditional video editing process and a novel method and computer apparatus of processing video clips by using templates combined with mobile devices connected through the internet to cloud hardware with a database schema FIG. 10 and certain machine code FIG. 17 and FIG. 18 and metadata information to track ownership rights of the composite videos FIG. 14.

The present invention saves hours of computer time by eliminating the majority of the traditional video editing cycle. The invention also provides a novel method to track the digital rights FIG. 14 to popular videos on behalf of the rights holders and the app users.

The present invention, in its preferred embodiment, allows a user to digitally process video and audio files by having the user select the roles and line he wants to play 402, record his/her takes 515 and 609, select his/her favorite take to process 604, and click render one touch 520 and you are in a movie. The present invention represents a significant reduction in total computing time compared to video editing using prior art software and equipment.

The present invention allows multiple users to take advantage of the method and system FIG. 13, whereby a user can perform as a film director 1301 and assigning acting roles to his friends and family 519, 1303 to 1307, whereby each role is a character in an original video work, record a set of takes for each assigned acting roles 518, and allowing the main user (director) to select which actors will play which roles in the modified video work to serve as a customized version of that video work.

The present invention also allows a user to create a composite movie mash or “actor's reel” FIG. 7B, FIG. 7C by combining many different renders from different movies and videos in the actor's library portal, by selecting scenes, ordering those scenes, and creating new video sequences for customized actor reels or movie mashes FIG. 19, including mix and match videos, and audio sampling. The present invention also allows for the creating fan movies with customized templates scenes to mix and match with other actor libraries, for example, to create “family reels” or “senior class” mash-ups FIG. 19.

FIG. 13, This invention creates a new market for movies, movie clips, music videos, television and sports videos, animations and other videos by allowing users to buy famous video clips or full movies, star in those movies with their friends and family, and then share or broadcast those videos through the application's distribution partners, or through the user's social media sites, subject to the license terms of the rights holders. This invention also creates a new market for video artists to come up with unique template ideas (i.e. mash ups) for users to act in. This invention also creates a new method of digital rights management FIG. 14 for the new composition and a new option to monetize those digital rights.

The present invention creates a novel method and computer apparatus to create and manage templates FIG. 1 and FIG. 10 and external video project files and integrate those templates and video project files with user takes corresponding to those templates and recorded on computer devices of the invention and to render user selected takes into those templates to create customized videos and movies.

The template creations FIG. 11 and FIG. 12 and management allows for the skipping of the traditional video editor user interface and instead allows for simplified user interface FIG. 5A-FIG. 5D. This method allows video editors to create one template, FIG. 8 or FIG. 9A-FIG. 9C, and allow millions of people to use that template to facilitate the mass production of customized videos. Example (1), if a user wants to make a customized version of an animated film, the template creator selects the film, sets up the roles to play in the template 911, and loads the various video clips and assets needed 910, configures the names of the video clips and audio clips to correspond to renaming of user takes, then process 520 the template with the user clips 604 to create a customized mash up video. The end result in the example would be a customized animated video with friends and family doing the voice overs for various characters in the video. Example (2), if a video artist creates a template to allow a user to sing along to a popular music video, the template creator creates the video image processing sequence once, and the users simply select the video which loads the template and assets, the user then sings along, the user then selects various settings 605 on how to render the final output, such as sing over original artist, sing along with original artist, display or hide video of user singing. This template could take any form, such as a simple picture-in-a-picture, a simple side-by-side video, to complex head-swapping between the user and the music artist, or complex face swapping between the user and the music artist or movie characters, or any other sequence of image and audio processing, as designed by the video template creator. This application dramatically extends the abilities of the average user to perform in major Hollywood blockbusters as well as create customized fan videos, by allowing users to skip all the complicated video editing steps and instead concentrate on a great performance.

This invention will allow for sale of music videos rather than just audio albums since music videos can now be designed for artist and fan interactivity.

Novel aspects of the invention also include a 1) new method and market for selling movie and music video clips, 2) new method and market to advertise movie and music video clips, 3) new video computer system FIG. 15 for creating customized movies and selling them 4) new method and market for selling customized templates of movies, music and video clips for video editors and artists. The present invention is a non-obvious, innovative breakthrough in video editing computer systems and methods of image processing and digital rights management that promotes the progress of useful arts.

New Applications with Novel Image Processing Method

In one embodiment, the present invention will allow for the creation of an entire new market for selling music, movie and TV videos. For example, currently music videos are not sold as a user product, rather they are used as marketing and promotion for music artists. Music videos are currently not marketed as a user product for a variety of reasons, including the cumbersome and lengthy effort needed to edit the video with current technology, lack of a simple method or standardized system with a simple user interface to allow users to find, select, edit themselves into a video, and then share that video, and the lack of any ability to track digital rights of the content owners of the new composite video. With the break-through of the current invention, music artists will be able to sell their music videos and allow consumers to create fan versions with those videos, including sing along with your favorite artist, air guitar contests with your favorite guitar player in side-by-side videos or green screening yourself into the videos so you are on stage with the artist, lip syncing in a side-by-side videos or a picture-in-a-picture, face swapping with their favorite artist while lip syncing or singing along, head swapping, and a variety of other fun ways to create a combined artist/fan video.

Likewise, the same novel aspects apply to sports video clips, such as head swapping with boxers in a boxing ring, or face swapping with Olympic® athletes receiving gold metals. Similar fun can be had with any popular TV show clip or movie, including politics, such as debate head swapping with candidates for political commentary or parody, or goofing on stupid TV commercials. Animations are particularly fun with this new invention. Users will be able to easily create voice overs or voice add ons with characters such as Bugs Bunny® or other popular animation characters. The present invention will allow the creations of customized movies such as Frozen®, where users can sing along to their favorite scenes and then broadcast those new videos, subject to licensing terms of the content owners, managed by the present invention's digital rights management algorithm and communications network.

The present invention includes the ability to broadcast 1309 customized videos on an AppleTV® app or other similar apps 1310 or upload to FaceBook® or YouTube® 1311 or other similar social media sites through another embodiment of the invention. This invention is unrivaled in its ease of use and as a novel method of video image processing and should lead to entire new consumer market place for videos.

### A Method for Compiling and Editing a Source Program

A method for compiling and editing a source program FIG. 17 and FIG. 18 using templates FIG. 11 and FIG. 12 that compile the sequence of computer commands based on user inputs FIG. 5A, FIG. 6A, FIG. 7B. The customized code is then compiled and executed on a server 101 or local machine 106 to process the digital video images and audio files. A system FIG. 13 of integrating mobile devices with recording and video and audio capture cards with cloud based servers to combine user recorded videos takes from their mobile or similar personal computer devices together with videos stored in a cloud based database structure, links with templates FIG. 11 and FIG. 12 that provide machines instructions FIG. 17 and FIG. 18 to create a new composite video from the user takes and the video, audio and image assets 910 loaded from the template database 1103.

### Method of Manufacturing

A method to mass produce customized videos using templates FIG. 11 and FIG. 12 to combine original videos with user takes, combine the videos into a new composition and to add metadata FIG. 14 to the composite videos to track that data across the communications network FIG. 13. The method includes a system and apparatus containing a lens 1501, microphone 1503, video capture card 1507, audio capture card 1504 to record the user takes, an internet connection 1510 or a CPU 1514, a connection 1517 to a cloud based server with data storage 1521, and a system of video monitors or televisions link to the internet for displaying the videos 1520.

### Billing Methods

A method performed by one or more processing devices, comprising presenting media content via an audio/visual display to a purchaser; presenting to the purchaser, at a point during presentation of the media content combined with a template option to process that media content; receiving, from the purchaser, information for purchasing the media content for a recipient; issuing, to the recipient, a purchase confirm number and storing the purchase media in the user's account. A method to provide payment for the new content created by processing the media content together with the user takes, using the instructions and metadata from the template, combined with user inputs on how to process the user takes, and then streaming the new video to end users for a pay per view fee. A method of combining the new combined video together with advertising and tracking the split of advertising revenue between the original content own, the new user takes, and the template artist.

### Method for Creating and Playing Customized Videos

A computer-implemented method for combining original media content FIG. 4A-FIG. 4D, with user created content FIG. 6A-FIG. 6B, user inputs FIG. 5A-FIG. 5D, and customized templates FIG. 8 and FIG. 9A-FIG. 9C that contain pre-sequenced machine code instructions FIG. 11, FIG. 12, FIG. 20 and FIG. 21 to then combine the user takes with the original media FIG. 19 and play the digital video asset on a computing device or transmit the video through the internet or wireless network to a television or other display or projection device FIG. 1 and FIG. 13, said method comprising: displaying a video information window having at least a video attribute area, the video attribute area displaying attributes of the digital video asset, and the preview selector facilitating a request to preview the digital video asset; receiving a selection of the preview; modifying the video to adjust for time syncing of audio or video with the original media; thereafter playing video information on the display device; a graphical user interface for playing a digital video asset on a computing device, the computing device having a display device associated therewith; computer program code FIG. 10, FIG. 17 and FIG. 18, for receiving a user input to render the composite video and playback selector to preview the digital media assets, users takes, and final render; computer program code for modifying the user takes, including syncing the audio or video and re-rendering media; computer code to track play back of video, computer code to search metadata of the composite videos and track rights information including number of times a video was watched and splitting any advertising revenues with the rights holders FIG. 14.

Method of Head Swap and Face Swapping with Stored Media

The method of digitally creating templates to process stored video media content with a person who the user wants to head or face swap with stored videos, FIG. 20 and FIG. 21, for example, Donald Trump® on the debate stage with Hillary Clinton®, (1) processing the original video through a API or algorithm to determine the head and face coordinates 2012 or 2111, storing the coordinates in a table with values for X, Y locations 2015 or 2114, width and height for each block outline for each feature on the face, including head rectangle boundaries, face rectangle boundaries, and other boundaries for eyes, mouth, nose, eyebrows, jaw, and other facial markers, on a frame-by-frame basis, then (2) repeating the process with a user take processing the user take through the same algorithm to calculate the head 2014 and face 2013 or 2113 coordinates of the user video, then calculating the scale factor between the original video and the user take 2016 or 2115, then (3) for head swapping FIG. 20, processing of the user take through a background subtraction algorithm 2011 so that the user is isolated from the background, then cropping the head from the user take on a frame by frame basis 2016, overlaying the head onto the original video on a frame-by-frame basis scaled to fit the extracted head coordinates of the target video, rendering the new video together with the audio to create a new final composite video 2017, or (4) extracting the face from the user video FIG. 21, scaling the face to the coordinate overlay points on the face in the target video 2114, then blending the overlay with the background and rending the output with the audio settings selected by the user 2116.

### Article of Manufacture and Saving it to Storage Device

The Article of Manufacture Method of saving software FIG. 16 to a CD, DVD, cloud storage 1605, laptop 1604 or home computer storage device 1607, including saving the software on DVDs 1606 to allow home users to create customized movies on home computers (DVD sales.) FIG. 13 and FIG. 15—An electronic communicator 1308 and 1510 stored via storage media, the storage media comprising: a first plurality of binary values 1508 for receiving a transmission and storing the transmission in a first data format 1301-1307; a second plurality of binary values for transforming the first data format to a second data format; a third plurality of binary values for scanning the second data format to determine a recipient of the transmission out of a plurality of potential recipients in a communications network, if no direct recipient is determined, a default recipient or a recipient identified by the third plurality of binary values as being the most likely intended recipient of the transmission is set to be the recipient; a fourth plurality of binary values for electronically routing the transmission 1309 and 1517 to a recipient chosen from the plurality of potential recipients by the scanning performed by the third plurality of binary values 1311; and a fifth plurality of binary values for storing log data to keep a history of past electronic routings of data.

### Database Structure

FIG. 10—The method and computer apparatus with data structures, including specific electrical or magnetic structural elements in memory and data stored in accordance with the database design, including physical entities that provide increased efficiency in computer operation and including metadata stored in the video, audio and image files, stored internally to the database or externally referenced by a URL or address location within the database. The various tables in the database may have multiple instances, depending on the variable settings and which layout the user is viewing.

### BRIEF DESCRIPTION OF THE DRAWINGS

FIG. 1 shows the Video Computer System to Create Custom Videos based Video Editing Templates, for use with TV sets, tablets, mobile devices, projectors, laptops, game consoles, augmented reality headsets, desktops and other computer devices that contain an audio mic, a video recording device, a display with speakers, memory storage, microprocessors, a means to transfer the video such as internet access and processors to digitally process the Images.

FIG. 2 shows the top-level User Decision Tree of a preferred embodiment of the video editing and digital image processing invention.

FIG. 3A shows the Main Menu layout that allows users to navigate a touch screen display on a mobile device of a preferred embodiment of the video editing invention.

FIG. 3B shows the Navigation drop down menu

FIG. 3C shows the navigate Step-by-Step How To menu

FIG. 4A shows the Browse Scenes layout that allows users to select a video clip from a favorite movie from a scrollable database of videos, TV broadcast or music video that have been added to the database along with a customized template of digital image processing instructions in order to allow the user to then swap themselves into the scene.

FIG. 4B shows the clips available to play and allows users to star their favorites and select a clip and send it to the editing room.

FIG. 4C shows clips available for a selected video or movie and allows a user to select a clip and send it to the editing room

FIG. 4D show detailed information about the movie or video clip

FIG. 5A shows the Edit Room layout that allows users to select the roles and lines to play after a user has selected a movie or video clip to customize and then record one or more takes of the users' performance(s) and select a performance to render.

FIG. 5B shows the cue card layout for the line selected and button options in the editing room FIG. 5A.

FIG. 5C shows the navigation buttons in the editing room FIG. 5A.

FIG. 5D shows the Actor's circle popup in the editing room FIG. 5A.

FIG. 6A, shows the Record Action layout that allows users to record multiple takes of their rendition of the scene they have selected to perform.

FIG. 6B shows the volume and video settings buttons in the Record Action layout FIG. 6A.

FIG. 7A, shows the Actor Reel layout menu that allows users to display their reels of customized videos and images, share with other users, message with other users, search for other actors to invite into their actor circles and collaboratively create Movies.

FIG. 7B, shows the videos saved in the Actor's personal library layout.

FIG. 7C, shows the layout for Actors to arrange their videos into an Actor's reel or mashup.

FIG. 8 shows the Create Template simple layout where “editors” can load media assets and create video templates to then edit those assets and integrate the user takes with those assets to create customized videos.

FIG. 9A, shows the Create Template Detailed layout where “editors” can load media assets and create video templates to then edit those assets and integrate the user takes with those assets to create customized videos. The detailed layout allows the editor to customize the scripting of the video editing process.

FIG. 9B shows a pop up of menu choices for template steps available to template creators in FIG. 9A.

FIG. 9C shows a pop up of dubbing and video display menu choices for how template users to grant as options to Actors for a given template for FIG. 9A.

FIG. 10 shows the Database Structure of a preferred embodiment that allows users to selected videos, move videos into edit rooms, create user takes of them own performances of those videos, create actor circles for groups of users who want to collaborate on creating a customized movie, and sharing those movies. The various tables in the database may have multiple instances, depending on the global variable settings and which layout the user is viewing, and which instance of the database table is being displayed to the user based on the layout and records being viewed.

FIG. 11 shows the Flowchart for Creating Templates from Series of Individual Image Processing Computer Instructions.

FIG. 12 shows the Flowchart for Creating Templates by Integrating with Full Pre-created Project File in External Video Editor.

FIG. 13 shows the Communications Network System Diagram of Various Users (Actors) and Users Groups (Actor Circles) for Group Collaboration of Video Mash-Ups.

FIG. 14 shows the Metadata Added to Videos, Audio and Images for Digital Rights Management and Revenue Tracking from Different Revenue Streams.

FIG. 15 shows the Computer Process Hardware of a preferred embodiment.

FIG. 16 shows the Article of Manufacture—write software to CDs, App Downloads to mobile or computer devices of a preferred embodiment to allow the software to be installed on DVD and other storage devices to allow for new user experiences on their home or mobile computer and display devices.

FIG. 17 shows the Computer Script Processes I, by group.

FIG. 18 shows the Computer Script Processes II, by group.

FIG. 19 shows the Process Flow Chart to Create a Mashup of multiple video clips, selecting the video clip to mash-up, re-ordering the video clips in the desired sequence, and rendering the mashup reel and storing the video with related metadata and right holder information.

FIG. 20 shows a Method of Digital Image Processing with Head Swapping with Human Face Recognition with Characters in Stored Videos Using Templates.

FIG. 21 shows a Method of Digital Image Processing with Face Swapping with Human Face Recognition with Characters in Stored Videos Using Templates

### DETAILED DESCRIPTION OF A PREFERRED EMBODIMENT

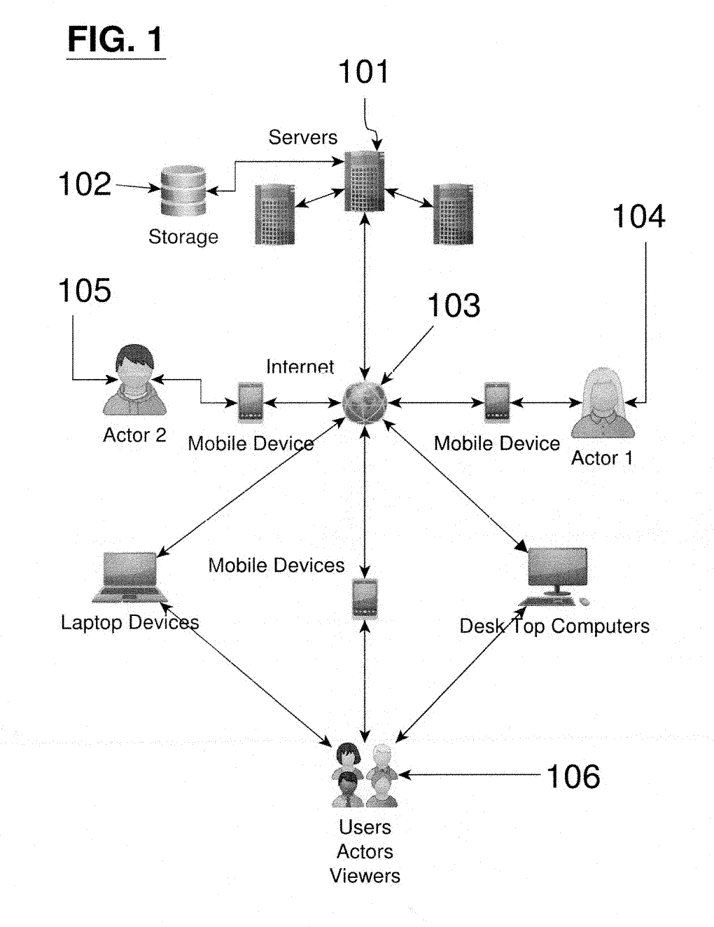

Referring to FIG. 1, a schematic of a computer system of interconnected devices to create custom videos based video editing templates and shared using computer hardware such as mobile devices, tablets, laptops, game consoles, augmented reality headsets, desktop computers, TV sets, cloud servers and the internet. In a preferred embodiment cloud servers 101 store movies, video clips, templates and user takes to process and create new video mash ups. Video mashers and template creators save to localized devices or cloud hard drives 102, using the internet 103, user 1 with device 104, user 2 with device 105, and the general public with device 106. This software has been developed to link a variety of devices together through a cloud based database through cloud servers 101 to allow users with a cell phone, computers with cameras and/or laptops to participate in customizing movies and videos posted in the database through automated editing. This software will store the database of videos available for editing in the cloud on storage devices 102. This software will also allow users the option to store their customized videos on their phone or on other storage such as a laptop, and will allow other users to view the customized videos by accessing the stored videos and downloaded app software and template instructions. This software uses the internet 103 to connect the server database with actors and their fans. As an example, User 1 with mobile recording device 104 could be an actor who plays a role in a movie clip, e.g. a voice for a character. As a second example, User 2 with mobile device 105 could be a second actor who plays a second role in a movie clip, e.g. a second voice. This software will allow for unlimited numbers of actors to play all roles in a movie, depending on how the template creator creates the automated edit for that movie or video clip. The general public with computer devices 106 is will then be able to view the customized videos. For example, in a Ku Fu Panda® scene, if a father and son play the roles of the father Panda and son Panda and their family can than watch the videos via this software, on their cell phones, television or computers.

The computer systems, processes and methods described herein can be implemented in a computing system that includes a back end components, which may include a data server, storage devices, streaming services such as Content Delivery Networks, an application server, or that includes a front end component, which included a client computing device such as a mobile device, computer or lap top, having a computer display with a user keyboard, either physical or on screen, video capture card, audio capture card, preferred display device will have a touch screen, or the system may include a Web browser through which a user can interact with an implementation of the computer systems, processes and methods described here, or any combination of such back end, transmission equipment, or front end components. The components of the system can be interconnected by any form or medium of digital data communication, such as a communication network, a local area network (“LAN”), a wide area network (“WAN”), and the Internet. The system can also be configured through CD, DVD and other storage devices through digital download from the internet and installed on localized computer devices.

The computing system can include client machines and server machines. A client machines and server machine are generally remote from each other and typically interact through both hard wired and wireless communication networks, such as the Internet. The relationship of client machines and server machines arises by virtue of computer programs running on the respective computers and having a client-server relationship to each other, connected through a communications network that users can search by metadata, and where the video play backs can be tracked and billings can be issued to the advertisers or sponsors and revenue can be split with between the digital rights holders.

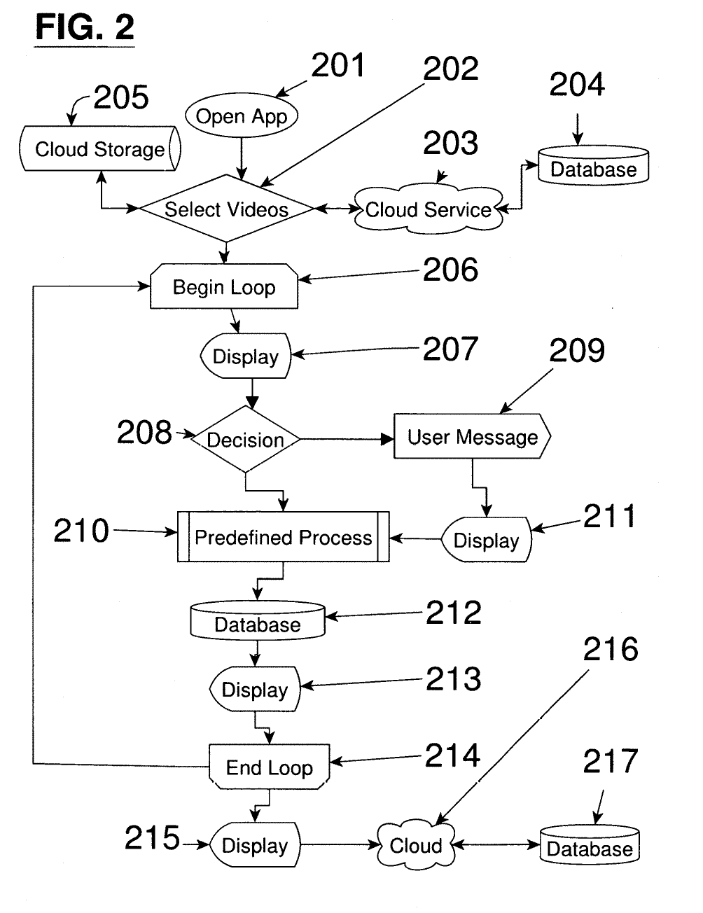

Referring to FIG. 2 a schematic of a User Decision Flow Chart the user must first start the application on their phone or other computing device, such as a laptop or computer. The user will then have to navigate through the application. The user can do a variety of functions: View how to videos, view movie and video clips for scenes to perform in, view actors' profiles and actor reels, rate actor performances, comment and message actors about their performances, ask another actor to join your actor circle and perform in clips with the user, create your own takes of a selected video, create a screen test video based on your user take and the selected video clip. The application will also allow users to manage settings such as language settings, services to purchase, such as movies and video clips to purchase, online storage options, contests for users to participate in, etc. The application will also allow content owners, such as movie studios, to manage their movies and video clips and manage what the users can do with those video clips through video clip licensing. In a preferred embodiment, a user opens software application on mobile device 201, the user makes a decision—view videos stored on database 202, a user accesses the cloud service 203, and accesses the database 204, a user selects a. video and the computer system then accesses the cloud storage 205 to then stream the video, if the user wants to select another video, a user begins loop 206, in a preferred embodiment, a user views display 207 and choses a scene to play. The portable device or mobile communication device may be a game console, augmented reality headset, smart phone or tablet, such as but not limited to, an iPhone®, iPad®, Blackberry®, Windows Phone®, Windows®, Mac OS®, or Android® enabled device, that preferably but not necessarily comprises at least an audio mic and video recorder, the user makes a decision to select a video “scene” to play 208, user receives a user message 209 which can include clip purchase instructions, rights restrictions, or links to sample scenes by other users, the system then accesses the predefined process 210 which creates an editing room for the video scene selected and records user purchase history and automatically navigates the user to the editing room where users can record takes on scenes, invites other actors to participate, in a preferred embodiment, a user views takes on the display 211, a user accesses the database 212 to stream the video, in a preferred embodiment, a user views display selects takes to render 213, a user end loop 214, in a preferred embodiment, a user views display of the rendered scene 215, a user accesses the cloud 216, a user accesses the database 217.

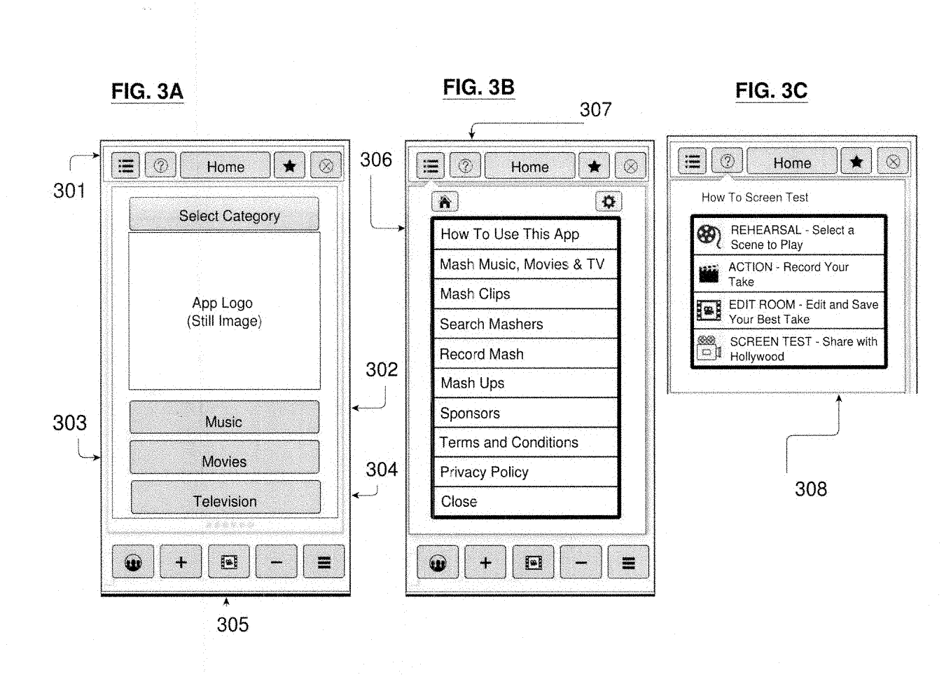

Referring to FIG. 3A perspective view of the display device showing the Main Menu includes a button to open navigator menu 301, includes a button to search music videos to screen test and mash up 302, includes a button to search movies & movie clips to screen test and mash up 303, includes a button to search television and sports clips to screen test and mash up 304, includes a button to navigate to edit room 305.

Referring to FIG. 3B, a perspective view of the display device showing the In a preferred embodiment navigator menu 306, button to open help popover (3C—308) 307, Referring to FIG. 3C. a perspective view of the display device showing the navigation popup menu for how to screen test 308 and may further comprise a separate, mechanical user interface, with, for example alternate style buttons, sliders or scroll bars that have script triggers associated with them,

With regard to FIG. 3C, a user has the option to Rehearse—Select a Scene to Play, Record Action—Record Your Take, go to the Edit Room—Edit and Save Your Best Take, and then Screen Test—Share with Hollywood and other users on the communications network of the video computer system for feedback and ratings. In the Rehearsal phase, the user will select a movie to play, and watch the movie scene several times and learn the lines of the actor the user wants to play. In the Action phase, once a user has selected a scene to play and has learned the lines of the character to play within that scene, the user then will select record, and record himself or have a friend record his performance. In the Edit phase—after a user has made a final take, the user will need to make sure his take is timed correctly to sync with the existing clip and many need to adjust setting and re-render once or twice in an iteration. Settings may also allow a user to zoom and center his performance in the viewer. Once a user has adjusted his take, he clicks on the render button and his scene will be processed and available to view. If he does not like the render, he may delete it and repeat the process. In the Screen Test phase, once a user is happy with his performance and wants to share it with friends and/or the public, he can do so through the sharing module within the mobile device and selected the sharing settings.

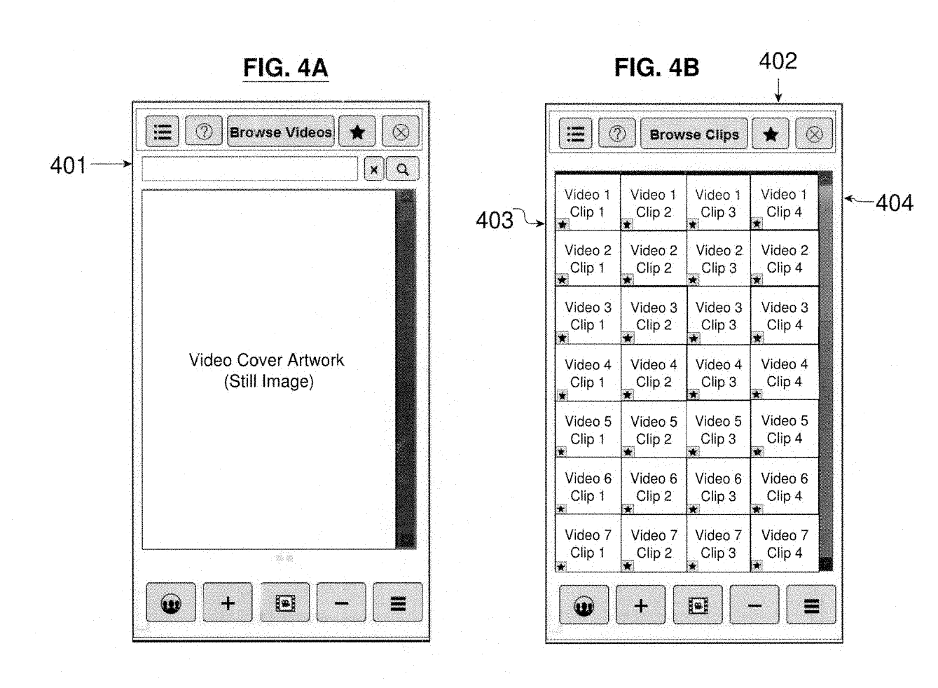

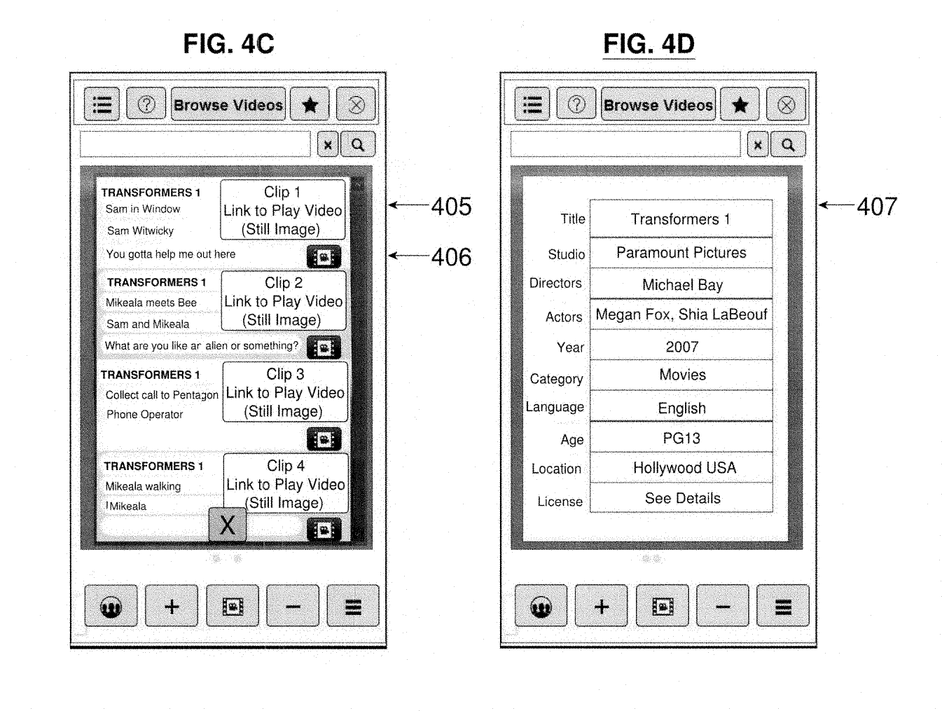

Referring to FIG. 4A perspective view of the display device showing the Browse Scenes, browse videos—search box 401, Referring to FIG. 4B browse clips button to show favorites 402, browse clips—button to star favorites 403, browse clips—click of video to play 404, Referring to FIG. 4C browse videos—swipe to left, layout to view video clips available to play for this movie or video 405, browse videos—button to select clip and stage it in an editing room 406, Referring to FIG. 4D swipe left again to show information on a video 407

Referring to FIG. 4A, FIG. 4B, FIG. 4C, FIG. 4D, Users have a search portal that allows a user to searches by all elements in the video clip database, including but not limited to film titles, studios, actors, directors, year of creation, and lines from movies. Once a user has entered in a criterion, the user can browse the results by swiping motions or pressing the “next” and “previous” arrows. The scroll down bar will allow the user to view the clips available for a selected movie or video to “scene play”, along with other information about the video.

Referring to FIG. 4D, A list of information about a video is provide to the user. The video database contains a variety of data items that can be entered to allow users to search for clips and learn about a movie or video clip. This will allow users to search for an actor, studio, etc. or search to clips available in a particular language, as well as license restrictions for clips offered by studios and content owners, etc. Each film may have many clips available for users to “scene play”. The clips are available by scrolling down and view the clips by tapping on the “image” of clip with a double tap, the video will play on the user's cell phone. The user will also the ability to view lines of clips. Below each clip are the lines of the scene for actors/users to learn prior to recording their takes. The user can star as favorites a clip or group of clips to easily find those clips at a later time without have to search for them again. Once a user has made a choice of a scene to play, the user hits the “send to edit room button to send clip to edit room. The user is then navigated to the edit room to record their takes and invite other actors to play.

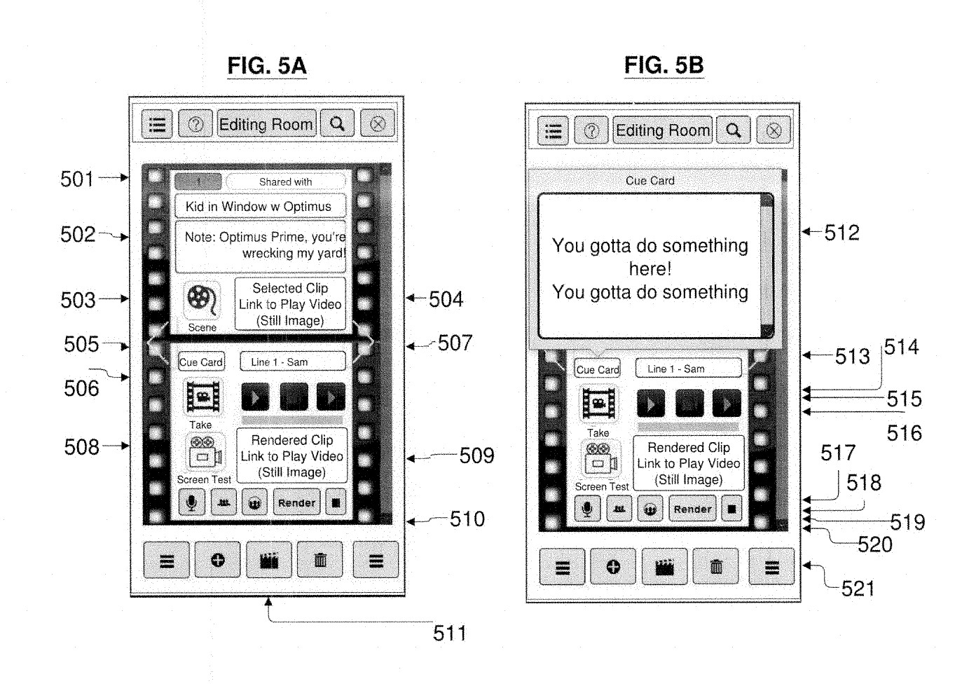

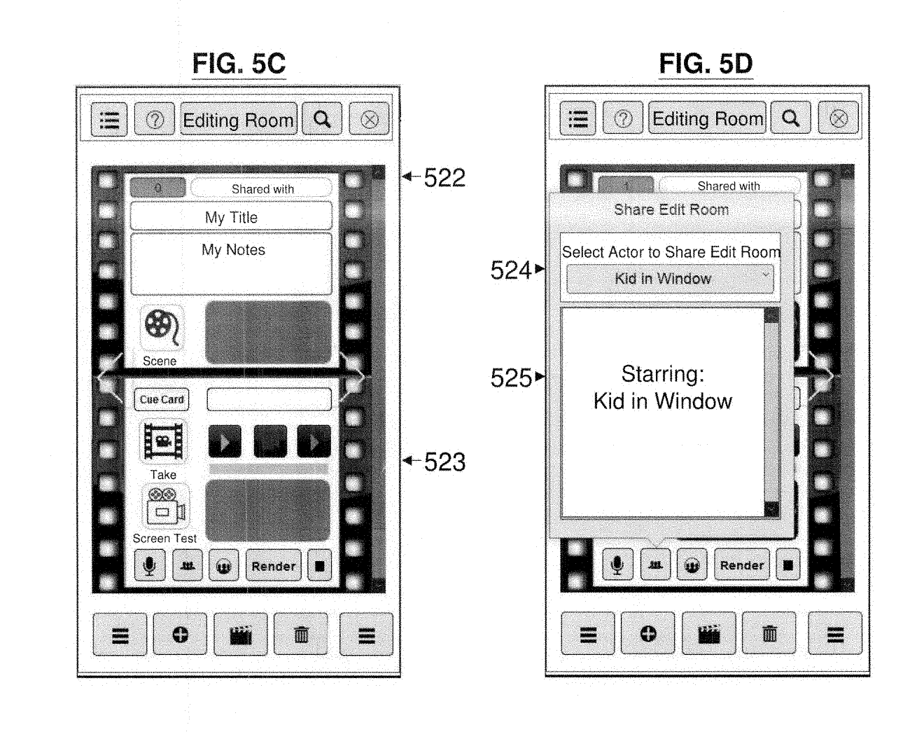

Referring to FIG. 5A, FIG. 5B, FIG. 5C, FIG. 5D perspective view of the display device showing the Edit Room layout which allows a user to scroll up and down through various Edit Room project, with a button to select current edit room 501 (which turns green to let the user know which edit room is in focus), text fields to allow users to add titles and notes to the edit room 502, scene button to allow users to navigate back to browse video clips layout if the user wants to switch scenes to play for a selected edit room 503, button image of selected video clip to play 504, button to navigate to previous edit room 505, button to select user take for a line 506, button to navigate to next edit room 507, button to send rendered video to the screen test portal 508, button image that plays the rendered video 509, scroll bar to scroll up and down edit rooms 510, button to navigate to action layout to record user takes for selected line to play 511, button to pop up cue card of actor lines to play for selected line 512, drop down menu to select roles and lines to play for selected video 513, button to play the portion of scene and selected line to play for rehearsal 514, button to quick record a user take 515, button to play back selected user take 516, button to select audio only for the selected scene to play 517, button to bring up actors sharing this edit room 518, button to manage actors in user's actor circle 519, button to render scene with user take 520, button to lock edit room to prevent it from being deleted 521, button turns red when edit room is shared with other actors in user's actor's circle 522, status bar of “render in progress” 523, pop up menu of actors in user's actor's circle to share edit room 524, list of actors sharing current edit room 525.

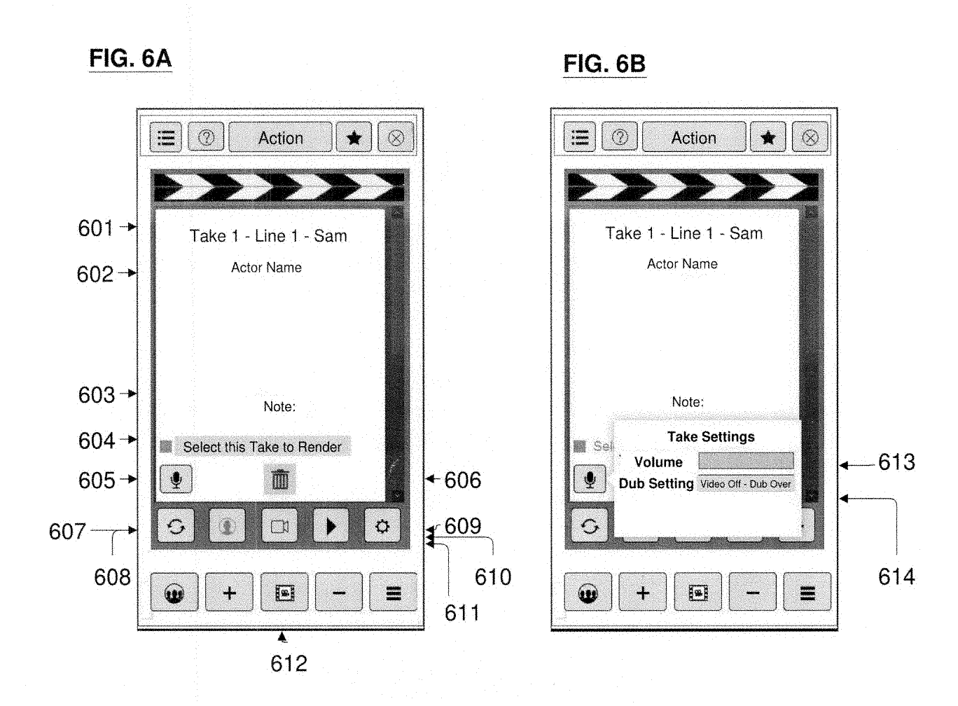

Referring to FIG. 6A, FIG. 6B perspective view of the display device showing the Record Action layout, a take title is automatically created from the user selected line and role and take number, e.g. 1 line 1 role Sam 601, actor name 602, text box for notes about user recorded take 603, box to select a take to render 604, button to select audio dubbing and video settings 605, button to delete take 606, refresh button to load image place saver for take 607, button to use front or rear camera (for mobile devices with dual cameras) 608, button to activate the camera to start recording 609, button to play the take 610, button to open the settings window 611, button to navigate back to edit room 612, volume setting to increase or decrease volume for user recorded take 613, pop up menu for user to select audio and video settings 614,

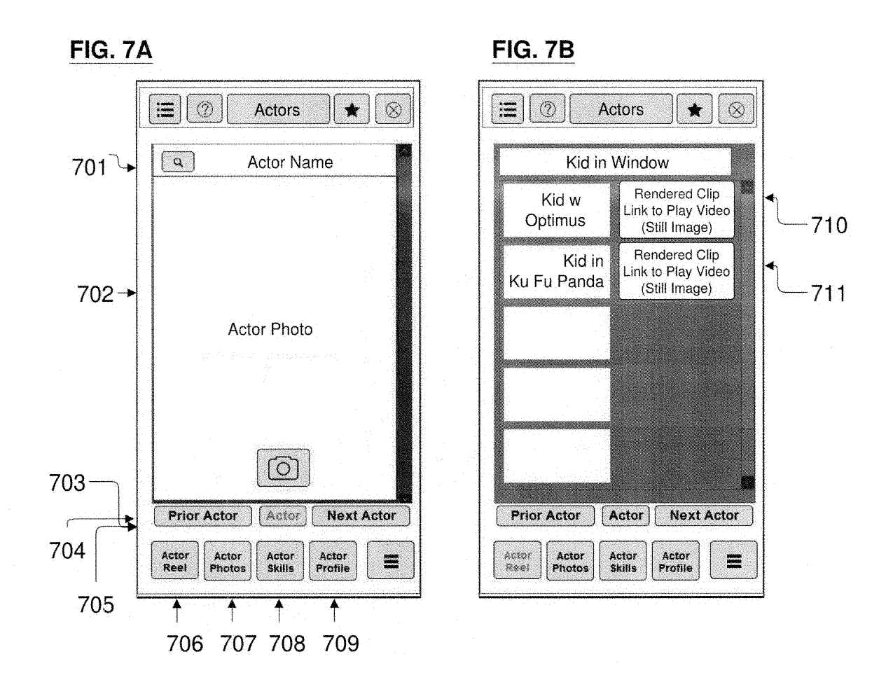

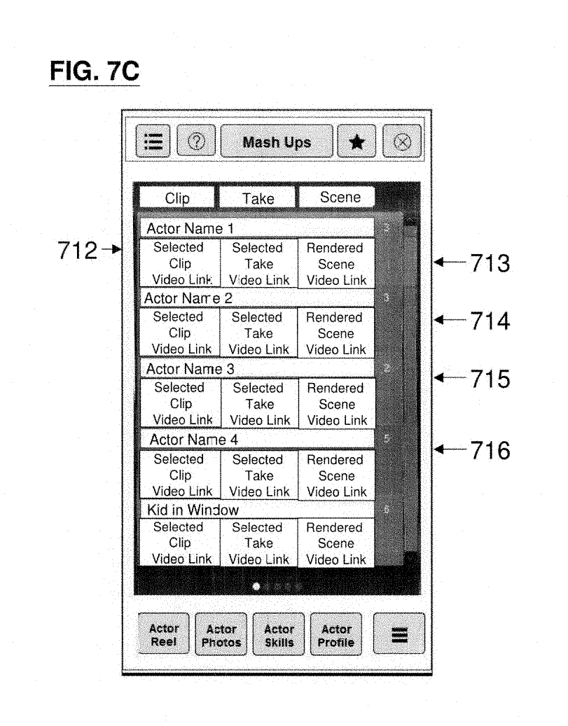

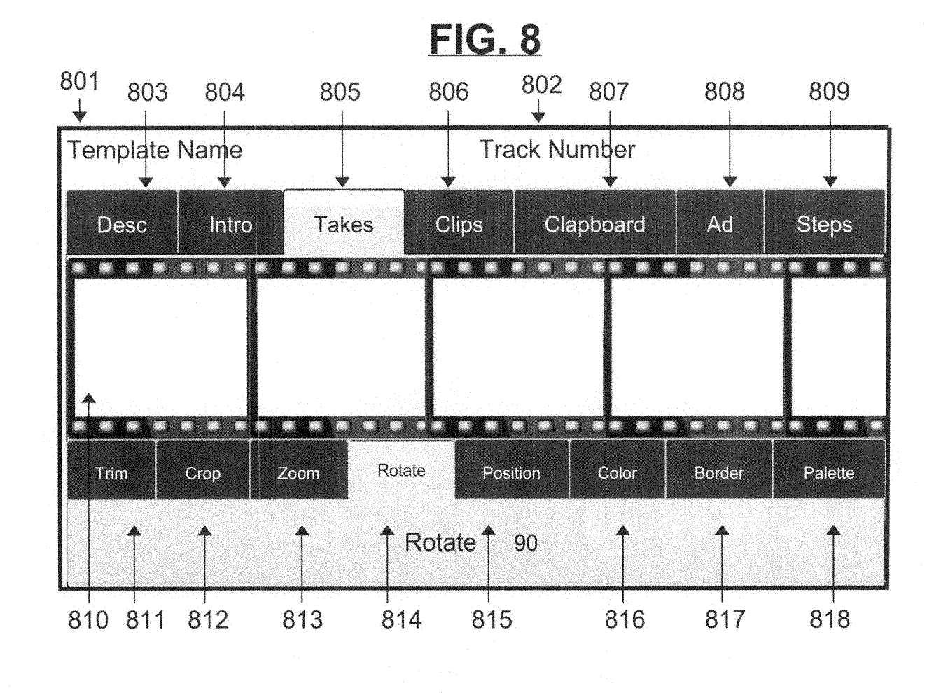

Referring to FIG. 7A, FIG. 7B, FIG. 7C, a perspective view of the display device showing the Actor Portal, Reel and Mash ups search box to search for actors 701, headshot for actor profile 702, button to navigate to prior actor 703, button to select actor 704, button to navigate to next actor 705, button to view user reel 706, button to view user acting photos 707, button to view user acting skills 708, button to view user acting profile 709, user reel button image to play video 710, user reel scroll bar to search for videos 711, mash up videos for all users sharing videos with the public 712, mash up scroll bar to search for videos 713, button image to play original video clip 714, button image to play user recorded take 715, button image to play user mash up video 716.

Referring to FIG. 8, a perspective view of the display device showing the Create Template Simple Layout. In a preferred embodiment, the layout contains a text box for template name 801, text box for template track number 802, button to input description of template 803, button to select introduction video or image to the final mock up render 804, button to give instructions to process user recorded takes by defining roles and lines for each role 805, button to add clips to process 806, button to add a clap board transition image or video in between the original video and the user take screen test 807, button to add and advertisement from selected sponsors to the end of each video 808, button to add processing steps to the template 809, container field strip to add sample takes or clips when the clips button is selected and then select each take to then add settings for each select take or clip 810, button to add image processing trim settings to the clip or take 811, button to add image processing crop settings to the clip or take 812, button to add image processing zoom settings to the clip or take 813, button to add image processing position settings to the clip or take 814, button to add image processing color settings to the clip or take 815, button to add image processing border settings to the clip or take 816, button to add image processing palette settings to the clip or take 817, button to add image processing crop settings to the clip or take 818. which together create the rendered video instructions, and then adding to the final composite video a list of metadata, including the template creator ID, the original content owner ID together with any co-owner IDs, (e.g. singer, song writer, publisher, etc.), together with the user ID, together with any additional actor IDs in the final render, as well as other metadata that may be used for tracking and searching across the communications network.

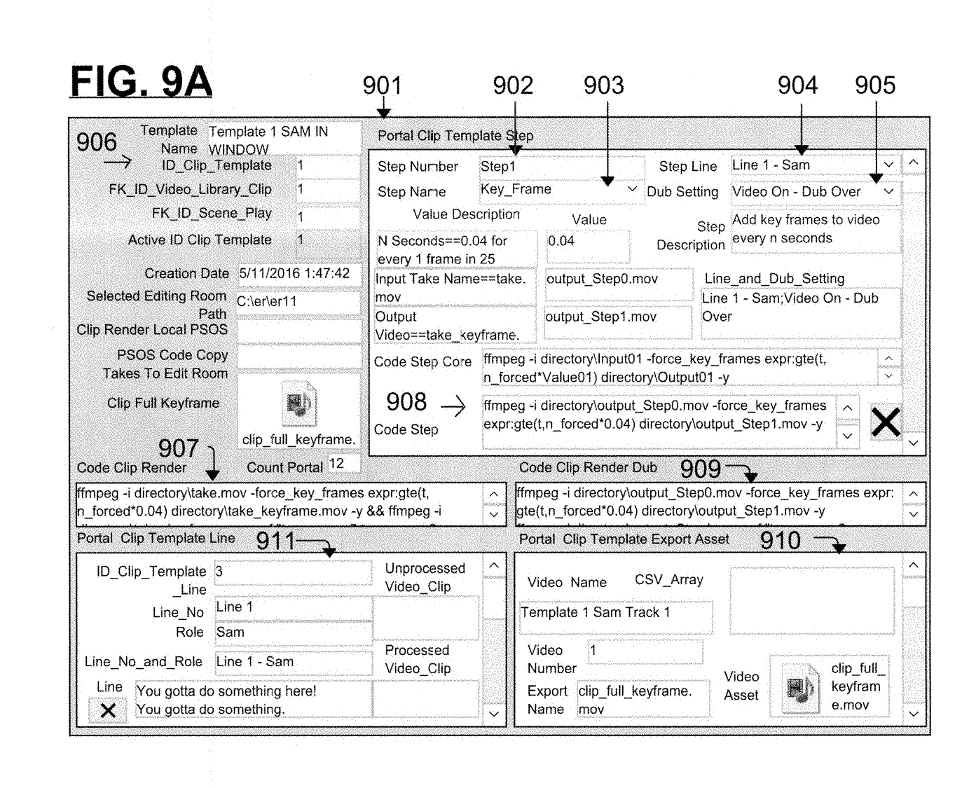

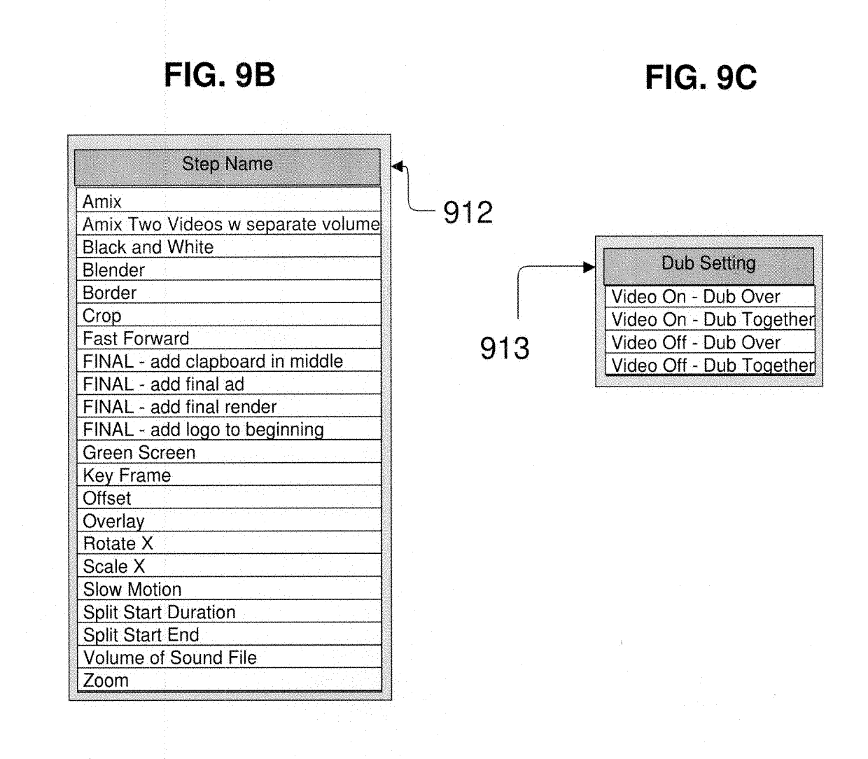

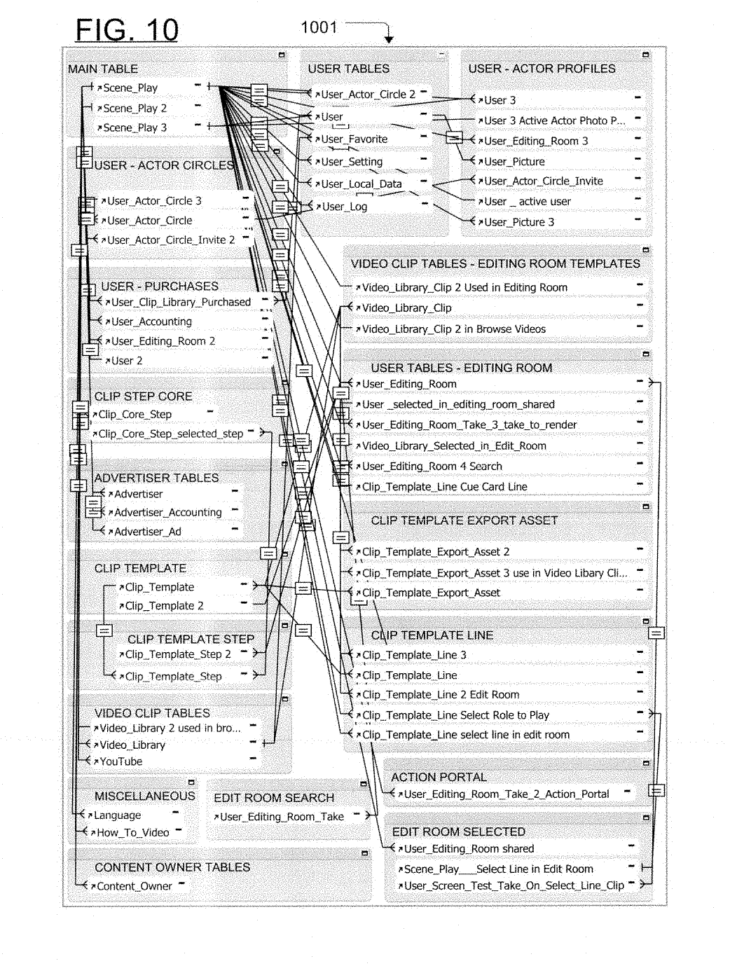

Referring to FIG. 9A, FIG. 9B, FIG. 9C, a schematic of a Create Template Detailed Layout creates a template from the detailed layout. 901, Referring to FIG. 9A, step number 902, select step from drop down menu 903, select line & role to process 904, select audio and video setting to process 905, information on the template 906, detailed code instructions generated from the template 907, detailed code instructions generated from the step selected 908, detailed code instructions generated from the template with line breaks 909, template files to export to temporary edit room folder for processing 910, set up roles to play with cue card dialog and clip setting or video sub-clips to aid users in practicing their lines 911 Referring to FIG. 9B, a list of drop down steps pre-programmed when user selects FIG. 9A 903. 912, Referring to FIG. 9C, a list of drop down audio and video settings to process when user selects FIG. 9A 905. 913, which together create the rendered video instructions, and then adding to the final composite video a list of metadata, including the template creator ID, the original content owner ID together with any co-owner IDs, (e.g. singer, song writer, publisher, etc.), together with the user ID, together with any additional actor IDs in the final render, as well as other metadata that may be used for tracking and searching across the communications network.

Referring to FIG. 10, in a preferred embodiment of the present invention, a schematic of a Database Structure to Select Videos, Record User Takes, and Automatically Edit Those Takes with Templates 1001, the database connects the users through a number of linked tables. The tables are all linked to the “Main” table through primary and foreign keys with record variables and global user variables that are session dependent. There are also multiple instances of certain tables, to allow table data to be displayed based on layouts, current records being displayed and global variable settings. There are several groups of tables that can be used to accomplish the present invention, including, but not limited to:
Main Table
   Main
Miscellaneous
   Language
   How to Video
User Tables
   User
   User Pictures
   User Favorites
   User Settings
   User Log
   User Local Data
   User Messages
   User Ratings
   User Purchases
   User Accounting
User Actor Circles
   User Actor Circles
   User Actor Circles Invites
User Editing Room
   User Screen Tests
   User Screen Tests Takes
   Clip Library Selected Video
Video Clips
   Content Owners
   Clip Library
   Videos

Video Clip Templates
Clip Templates
   Clip Templates Steps
   Clip Templates Tracks
   Clip Templates Track Clips
Advertisers
   Advertisers
   Ads
   Advertiser Accounting

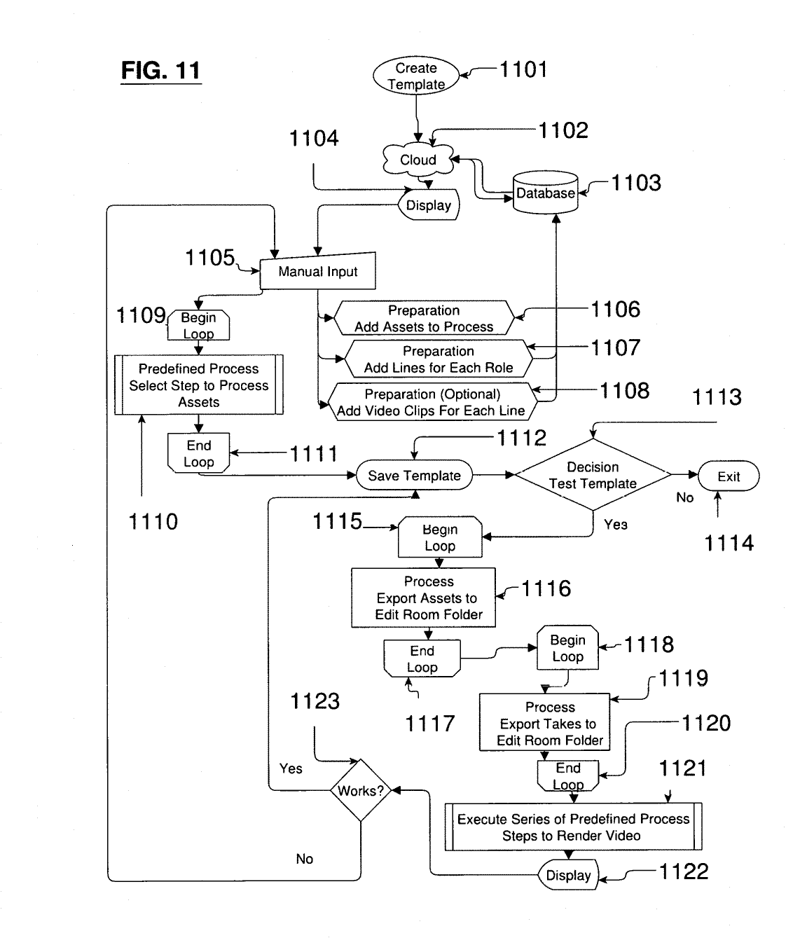

Referring to FIG. 11, a schematic of a Flow Chart for Creating Templates from Series of Individual Image Processing Computer Instructions allows a video editor to create a template from a series of individual image processing computer instructions 1101, in a preferred embodiment, the processing will be done on a cloud computing device, including a server, processor, and digital storage 1102, database stored on the cloud storage 1103, connected to a user through a computer display monitor for programming 1104, to allow for the input of template data by video editor/programmer who is creating or editing a template 1105, input assets to process, including images, videos and audio files 1106, input lines and roles to play for video 1107, input video clips for each line (optional) to aid users in rehearsals of acting roles/parts 1108, begin selection process of steps to add to the template to process user takes 1109, add predefined step to process interim image files 1110, end loop after all steps have been added to process the steps necessary for all interim image processes 1111, save the template 1112, decision to test the template 1113, no testing, exit template creator layout 1114, test the template, begin test loop 1115, loop through exporting all template assets to the editing room folder 1116, end loop 1117, begin loop 1118, export takes to editing room folder 1119, end loop 1120, execute series of predefined process steps to render video 1121, display rendered video on monitor 1122, template creator decision, does the template work, yes, exit, no, adjust the steps and repeat the test 1123. The metadata is automatically added to the video, audio and image files, necessary to track the template and the videos created by the template across the communications network, including the template creator ID, the original content owner ID together with any co-owner IDs, (e.g. singer, song writer, publisher, etc.), together with the user ID, together with any additional actor IDs in the final render, as well as other metadata that may be used for tracking and searching.

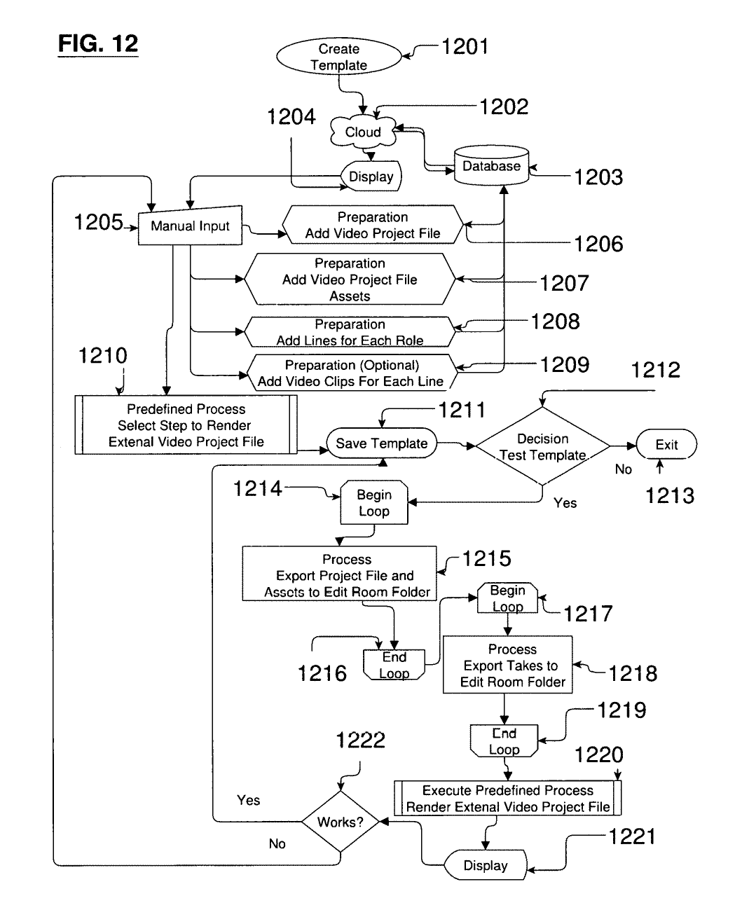

Referring to FIG. 12, a schematic of a Flow Chart for Creating Templates by Integrating with Full Pre-created Project File in External Video Editor allows a video editor and template creator to create a template by integrating with a full pre-created project file in external video editor 1201, in a preferred embodiment, the processing will be done on a cloud computing device, including a server, processor, and digital storage, 1202, database stored on the cloud storage 1203, connected to a user through a display monitor on a local computer for programming the template digital image processing steps 1204, input of template data by video editor/programmer creating or editing a template 1205, input video project file 1206, input video project file assets 1207, input lines and roles to play for video 1208, input video clips for each line (optional) to aid users in rehearsals of parts 1209, add predefined step to process project file with new user takes 1210, save the template 1211, decision to test the template 1212, no testing, exit template creator layout 1213, test the template, begin test loop 1214, test the loop through exporting all template assets to the editing room folder 1215, end loop 1216, begin loop 1217, test export takes to editing room folder 1218, end loop 1219, execute predefined process steps to render video with project file from external video editor 1220, display rendered video on monitor 1221, template creator decision, does the template work, yes, exit, no, adjust the steps and repeat the test 1222. The metadata is automatically added to the video, audio and image files, necessary to track the template and the videos created by the template across the communications network, including the template creator ID, the original content owner ID together with any co-owner IDs, (e.g. singer, song writer, publisher, etc.), together with the user ID, together with any additional actor IDs in the final render, as well as other metadata that may be used for tracking and searching. In a preferred embodiment, the process creates a fold based on the unique ID key of the Edit Room selected by the User. The edit room contains the selected video to render and all takes for this edit room are referenced by foreign keys, linking the take to the edit room. If the user invites another actor to perform on this video clip, the tapes of the additional actor will also be linked to this edit room, and visible to all actors within the edit room so that friends and review and pick the best performance for each role or line within each scene. During testing of the template, the full sequence of the end user is tested. The steps for testing include creating user takes to test out each role and the processing of those roles. After the user/tester selects which takes to render, the template than processes those takes by copying them to the edit room folder after a temporary copy of the template assets has be copied into the edit room and the application then copies the selected video takes and renames them based on the roles and lines, as specified in the template corresponding to the template assets which is being modified. The template instructions are written to process the video based on user/tester settings offered for each clip, which are then applied in the final render. For example, if the audio is set for video off, dub over, the template will have the user's video shut off, and the audio track will replace the related track in the original clip in the final render. Once all the assets and user takes are copied into the edit room, the video is then rendered using the external editor's command line rendering instructions, with the final output saved to the edit room and loaded to the preview button for the user/test to review. The system copies the final output to the final render storage location managed by the database and the temporary edit room and all its files are deleted. The video and audio processing can also be done on a localized machine if the user opts to download or install from a storage device the full application.

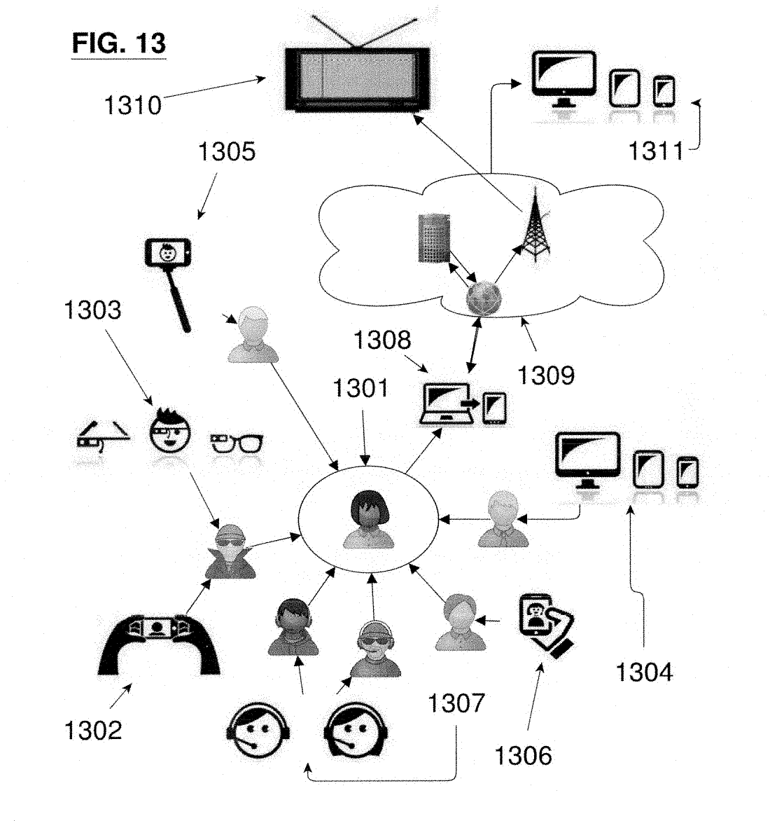

Referring to FIG. 13, a schematic of a Communications Network System Diagram of Various Users (Actors) and Users Groups (Actor Circles) for Group Collaboration of Video Mash Ups. In a preferred embodiment, a user may want to create a mash up video and may want to collaborate with other actors. in a preferred embodiment, a user can invite other users/actors in her circle 1301, a user selects a line to play and records performance with a mobile phone with a video and audio recording device 1302, user selects a line to play and records performance with a video and audio recording device mounted in eye wear 1303, user select a line to play and records performance with a video and audio recording device, including tablets, desk top and lap tops 1304, user select a line to play and records performance with a recording device and a selfie stick 1305, user select a line to play with a recording device and a selfie stick 1306, user select a line to play and is recorded by a friend with a mobile video recording device 1307, user/director selects with takes to use in the final video mash up and sends those video via a computer device 1308, user send instructions to process video on cloud server via the internet 1309, user selects to share video mash up with private user group or with the public via television, such as an apple tv channel or YouTube channel 1310, user selects to share video mash up with private user group or with the public via internet, such as YouTube channel 1311,

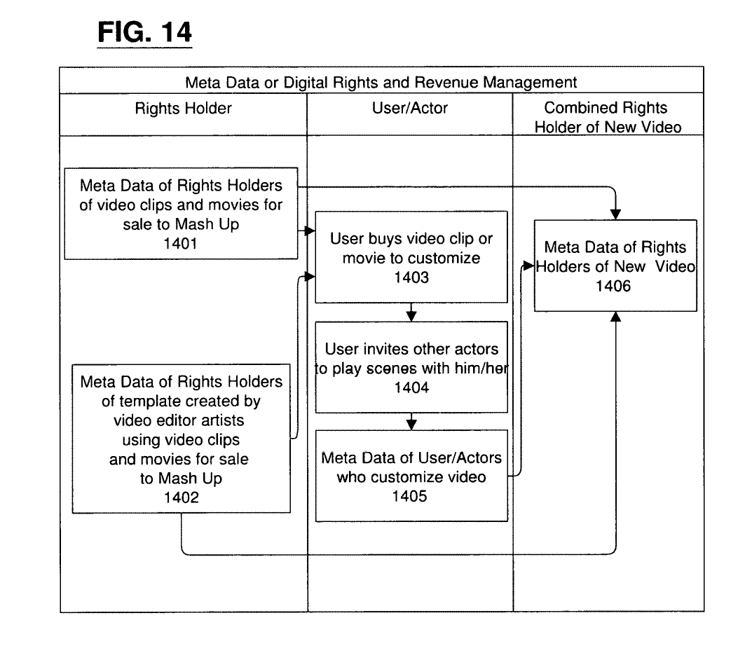

Referring to FIG. 14, a schematic of a Metadata Added to Videos, Audio and 19 Image files for search and tracking content across the Communications Network. The Diagram of Digital Rights Management and Revenue Tracking from Different Revenue Streams, in a preferred embodiment, the video computer system will add to the final videos 1406, to include rights holders of video clips together with rights holder of audio tracks and images used, and movies for sale to mash up 1401, plus the rights holders of template created by video editor for the movies for sale to mash up 1402, and after the user buys video clips or movie to customize 1403 a the clip is tracked in the users accounting profile so that the user can access the video clip per the terms of the rights holder. Once the user's purchase is validated, the user can invite other actors to play scenes with him/her 1404, and when the user takes are selected for rendering, each of the user takes are then modified to include the metadata of their user IDs, and the user customizes video and renders the final video 1405, and the system adds the metadata from all rights holders to the final mash up video 1406. In a preferred embodiment, the metadata includes the table references including the table ID key for each original rights holder's name, such as artist or Hollywood studio, the table reference to the ID key for other rights holders if there is a split in revenues, such as writers and musicians, screen actors' guilds, etc. the table ID key for the template creator, the ID key for the each of the users/actors in the final render. Other information may also be added besides the reference ID keys to each of the rights holders, such as the license ID references, the software ID references, company name and other identifying information to track the video or audio files when they are published externally, such as posting to FaceBook®. The meta data to use in the videos may also include the names of users/actors depending on the privacy settings of each user if the users/actors want their names public or private, as well as links to the users' profiles within the computer data base system, and any external links to the users' social media profiles.

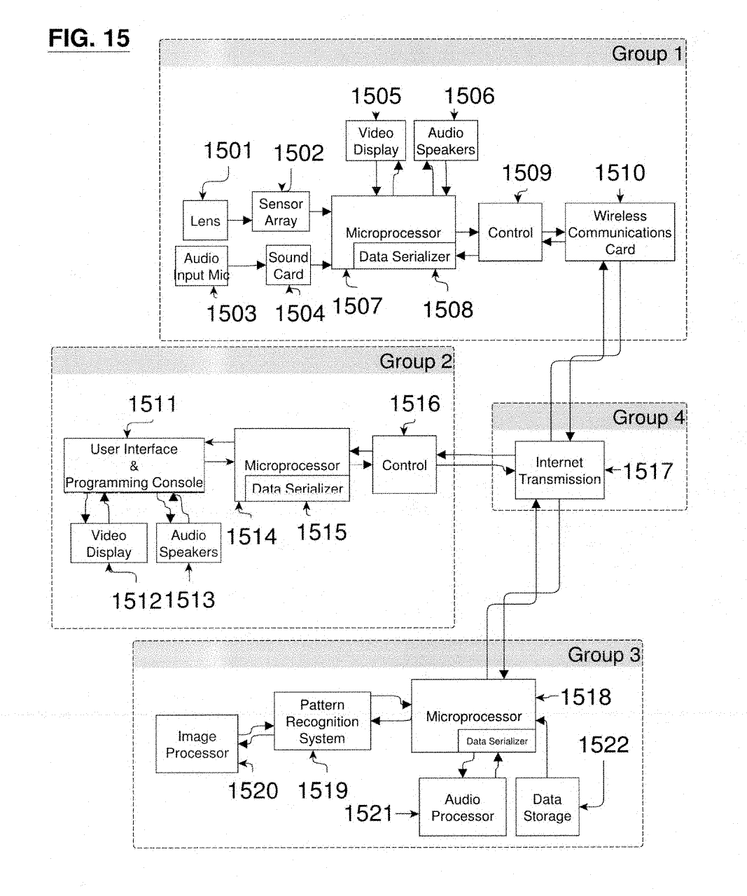

Referring to FIG. 15, a schematic of a Computer Process Hardware, consisting of a lens 1501, sensor array 1502, audio input mic 1503, sound card 1504, video display 1505, audio speakers 1506, microprocessor 1507, data serializer 1508, control 1509, wireless communications card 1510, user interface and programming console 1511, video display 1512, audio speakers 1513, microprocessor 1514, data serializer 1515, control 1516, internet transmission 1517, microprocessor with data serializer 1518, pattern recognition computer process 1519, image processor 1520, data storage 1521,

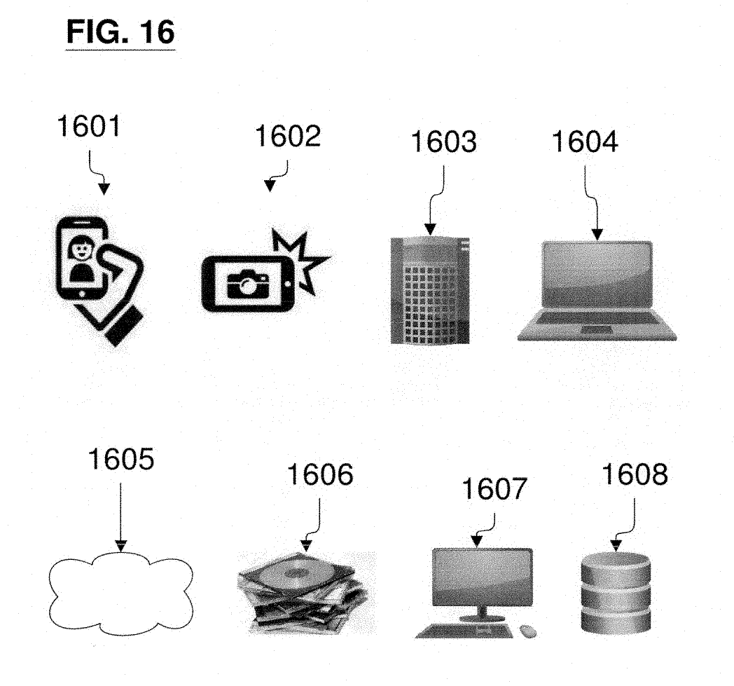

Referring to FIG. 16 an illustration of various Articles of Manufacture—write software to CDs, App Downloads to devices, etc.—includes an article of manufacture on a mobile device 1601, includes an article of manufacture on a tablet device 1602, includes an article of manufacture on a server computer 1603, includes an article of manufacture on a cloud computer 1604, article of manufacture on a cd or dvd 1605, includes an article of manufacture on a desk top computer 1606, includes an article of manufacture on a laptop computer 1607, includes an article of manufacture on a storage device 1608, which may include storage in other devices such as games consoles, or augmented reality headsets.

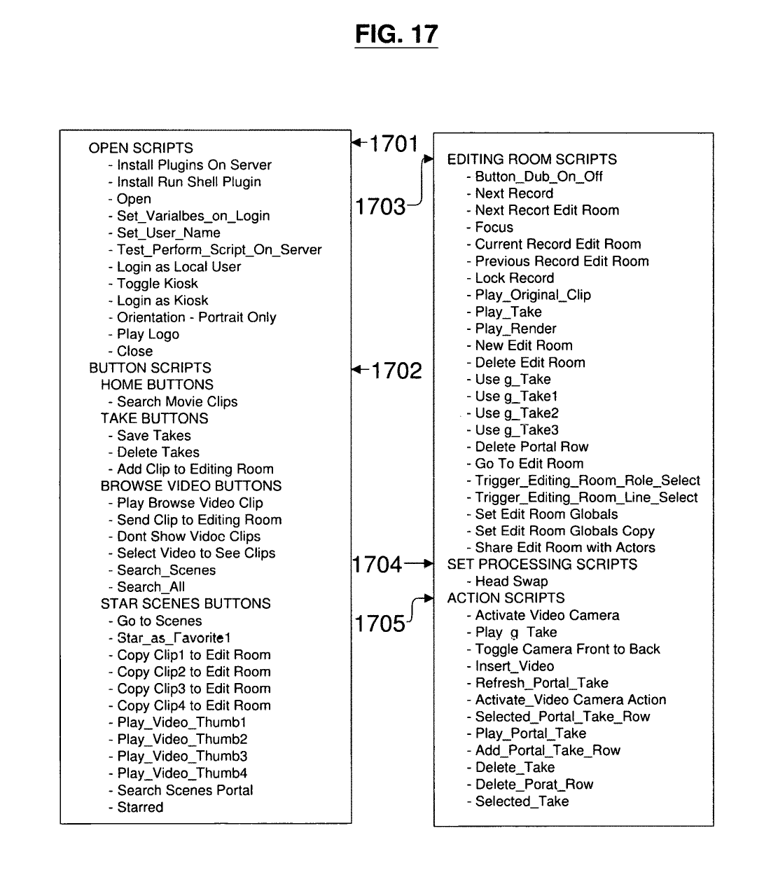

Referring to FIG. 17, an illustration of lists of various computer process scripts that activate based on user selected inputs, such as navigation between records, or render video in a preferred embodiment the scripts can be grouped into major sections. referring to FIG. 17, the first main section of scripts are scripts to process while opening and closing the application, including loading any external functions or plugins, setting global variables, setting user preferences such as language or last saved configurations, saving all data prior to exiting, 1701 a group of scripts includes when a user accesses the scripts to process various tasks when users press a button through the application, such as play videos, star scenes, load videos and templates, save takes, delete takes, search scenes 1702 a group of scripts includes when a user accesses the scripts to process for the editing room layout, including navigation between editing room records, locking records, playing videos, recording videos 1703 a group of scripts includes when a user accesses the scripts to process when the user selects a video template to head swap or face swap 1704 a group of scripts includes when a user accesses the scripts to process for the action layout, including recording a new take, deleting a take, selecting a take to render, editing settings for a take 1705 in the device which may further comprise a separate, mechanical user interface, with, for example alternate style buttons, sliders or scroll bars that have script triggers associated with them.

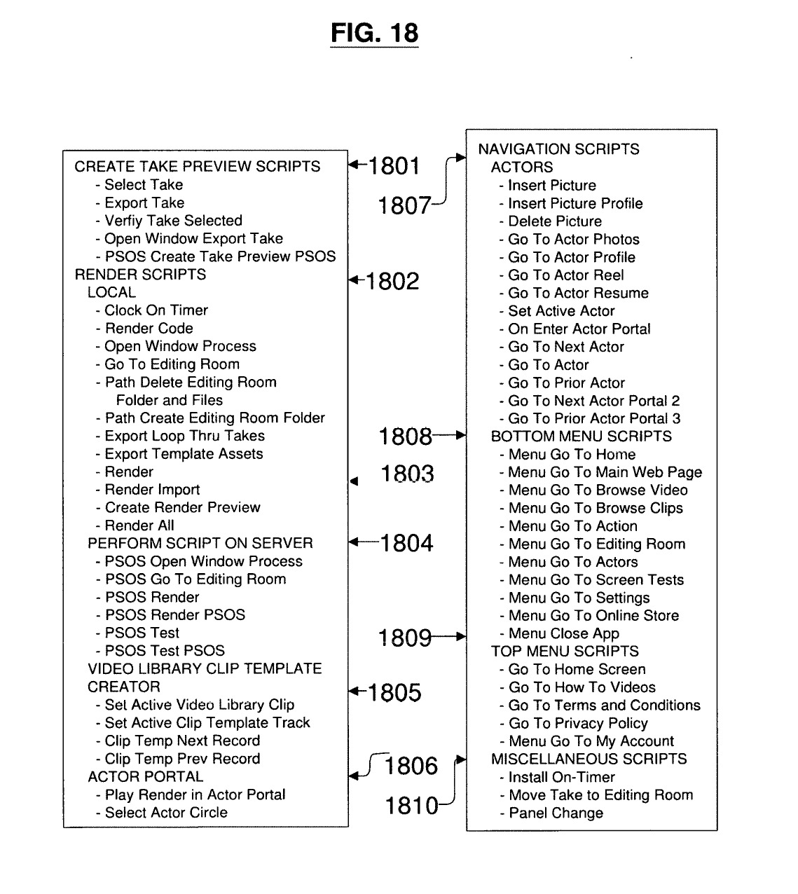

Referring to FIG. 18, a continuation of lists of various computer process scripts from FIG. 17 that activate based on user selected inputs, such as navigation between records, or render video in a preferred embodiment the scripts can be further grouped into major sections. referring to FIG. 18, a group of scripts includes when a user selects to preview a user take 1801, a group of scripts to process when the user selects render a mash up video with selected user takes 1802, a group of scripts to process locally when user selects to render a mash up 1803, a group of scripts to process on server psos (perform script on server) when the user selects to render mash up 1804, which include a script to add metadata to the video, audio and image files, a group of scripts to process in the video library clip template creator 1805, a group of scripts to process in the actor portal, including play video mash ups, select actor circles and render mash ups 1806, a group of scripts to process when the user selected a navigation button 1807, a group of scripts to process when the user selects a button on the bottom menus 1808, the next group of scripts to process when the user selects on the top menus 1809, a group of scripts to process that are miscellaneous and not previously mentioned above 1810, in the device which may further comprise a separate, mechanical user interface, with, for example alternate style buttons, sliders or scroll bars that have script triggers associated with them.

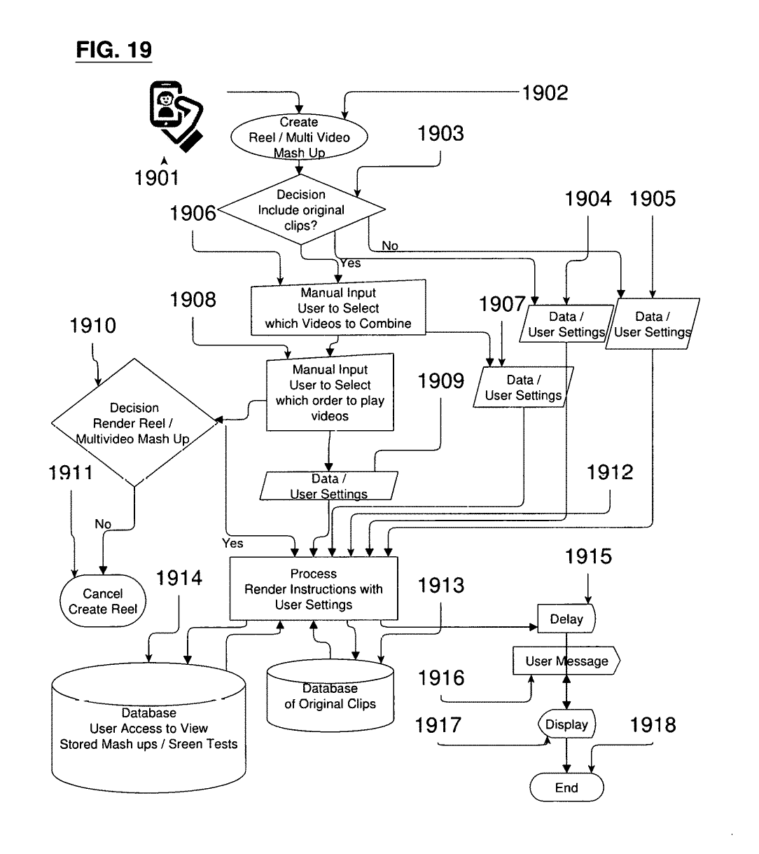

Referring to FIG. 19 Process—Flow Chart to Create Mashup, in a preferred embodiment, a user activates the app on a mobile device or computer 1901, user navigates to actor reel layout to create a mash up 1902, user selects settings to include original clips 1903, yes—data saved in user settings 1904, no—data saved in user settings 1905, manual input user to select which videos to combine 1906, a schematic of a data saved in user settings 1907, manual input user to select which order to play video 1908, data saved in user settings 1909, decision render reel/multivideo mash up 1910, yes—process render 1911, process render instructions with user settings 1912, database of original clips 1913, database user access to view stored mash ups/screen tests 1914, display processing render status bar on user device 1915, send user a message when render is complete 1916, display render image when complete to play render when selected 1917, exit the layout 1918. The mash up video can also incorporate additional metadata that has not already been added to the individual clips.

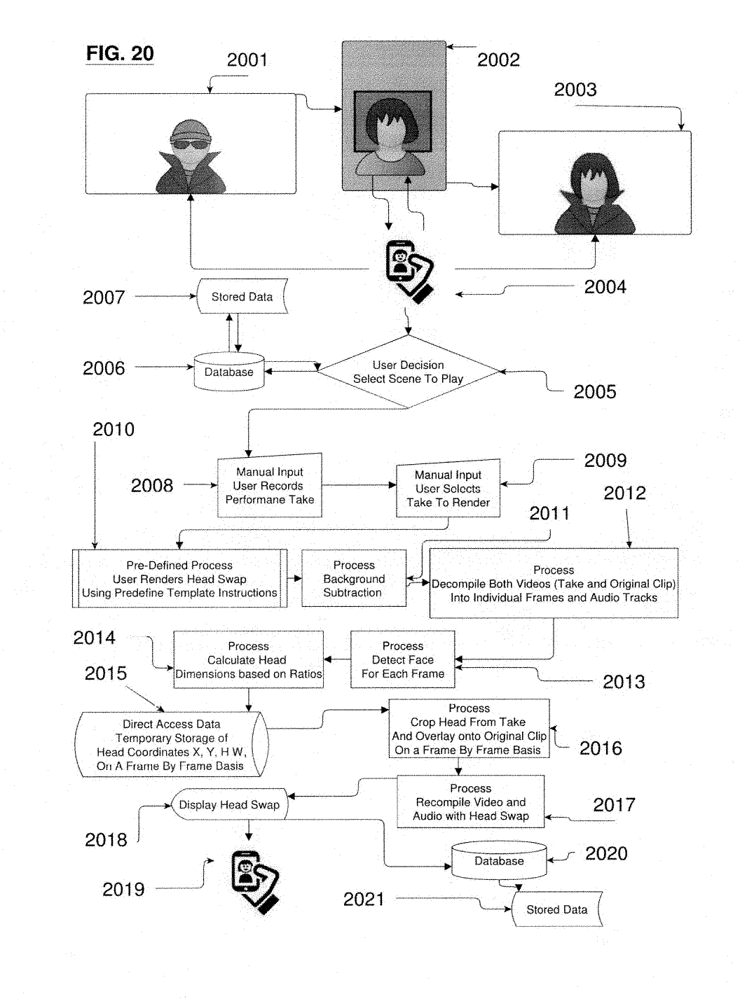

Referring to FIG. 20, a flow chart of the Method of Digital Image Processing with Head Swapping with Human Face Recognition With Characters in Stored Videos Using Templates, wherein a user selects a scene to play and head swap themselves into the original scene 2001, user records a take, which is run through various processes to isolate the users head from the background 2002, user renders the final mash up video where the user's head is swapped into the original video together with the user audio dub settings while the rest of the scene remains the same 2003, user starts the process by opening the app on a mobile device, with a lens, a mic and video and audio capture cards 2004, decision—user reviews and selects a scene to play 2005, database access—user then accesses the database on a cloud server or scenes previously purchased or downloaded to the user device 2006, data storage access the app database accesses videos in storage on the cloud servers or on the user's local device 2007, manual input—user then records one or more performance takes on the scene, and if there is more than one line, multiple takes may be necessary to render the full scene 2008, manual input—user then selects which take(s) to render 2009, pre-defined process—user renders head swap using predefined template instructions and the head swap script steps 2010, process—video is passed through a background subtractions filter. a simple background subtraction filter may include an additional input from the user of a still image of the background, or the user can step out of a frame and capture the background to subtract out of the user video take 2011, process decompile both videos (take(s) and original clip(s) into individual frames and audio tracks 2012, process—detect face for each frame 2013, process—calculate head dimensions based on ratios 2014, direct access data—create a temporary array of values, frame-by-frame, including the x, y, width and height coordinate for the outer boundary of the detected head 2015, process—crop head from user take and overlay onto original clip on a frame-by-frame basis 2016, process—recompile mash up video of images with head swap overlays with audio tracks, per user dub settings, including metadata to track digital rights 2017, display—show the head swap video on user device if mash up was rendered locally on user device 2018, send video stream to user device if mash up was rendered remotely on server 2019, access database update digital rights with new actor information 2020, save render to server storage device or local user device and add metadata to final composite video 2021

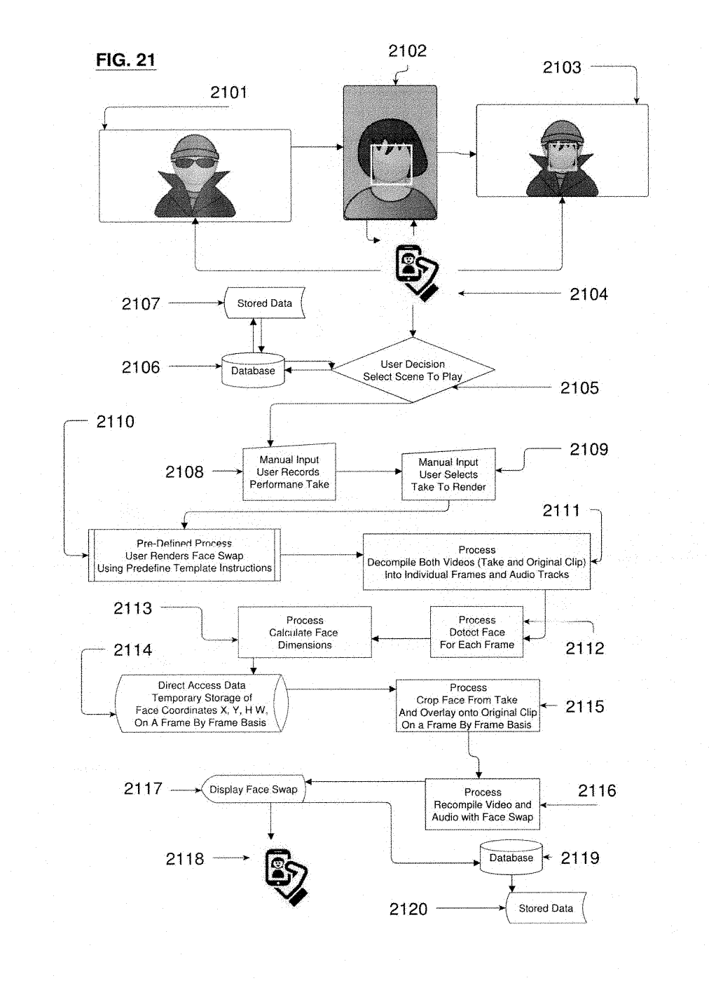

Referring to FIG. 21, a flow chart of the Method of Digital Image Processing with Face Swapping with Human Face Recognition With Characters in Stored Videos Using Templates, wherein a user selects a scene to play and face swap themselves into the original scene 2101, user records a take, which is run through various processes to isolate the user's face 2102, user renders the final mash up video where the user's face is swapped into the original video, together with the user audio dub settings, while the rest of the scene remains the same 2103, user starts the process by opening the app on a mobile device, with a lens, a mic and video and audio capture cards 2104, decision—user reviews and selects a scene to play 2105, database access—user then accesses the database on a cloud server or scenes previously purchased or downloaded to the user device 2106, data storage access—the app database accesses videos in storage on the cloud servers or on the user's local device 2107, manual input—user then records one or more performance takes on the scene, and if there is more than one line, multiple takes may be necessary to render the full scene 2108, manual input—user then selects which take(s) to render 2109, predefined process—user renders face swap using predefined template instructions and the face swap script steps 2110, process—decompile both videos (take(s) and original clip(s) into individual frames and audio tracks 2111, process—detect face for each frame 2112, process—calculate face dimensions, including dimensions of face parts such as eyes and mouth 2113, direct access data—create a temporary array of values, frame-by-frame, including the x, y, width and height coordinate for the outer boundary of the detected face, including face parts 2114, process—crop face from user take and overlay onto original clip on a frame-by-frame basis 2115, process—recompile mash up video of images with face swap overlays with audio tracks, per user dub settings, including metadata to track digital rights 2116, display—show the face swap video on user device if mash up was rendered locally on user device 2117, send video stream to user device if mash up was rendered remotely on server 2118, access database update digital rights with new actor information 2119, save render to server storage device or local user device and add metadata to final composite video 2120.

### Electrical Description

These computer programs (also known as programs, software, software applications or code) include machine instructions for a programmable processor 1507, and can be implemented in a high-level procedural and/or object-oriented programming language FIG. 17 and FIG. 18, and/or in assembly/machine language. FIG. 16—As used herein, the terms “machine readable medium” “computer-readable medium” refers to any computer program product, apparatus and/or device (e.g., magnetic discs, optical disks 1605, memory 1608, Programmable Logic Devices (PLDs)) used to provide machine instructions and/or data to a programmable processor, including a machine-readable medium that receives machine instructions as a machine-readable signal. FIG. 15. The term “machine-readable signal” refers to any signal used to provide machine instructions and/or data to a programmable processor. To provide for interaction with a user, the computer systems, processes and methods described here can be implemented on a computer having a display device 1520 (e.g., a CRT (cathode ray tube), LCD (liquid crystal display) monitor, or projection such as a holographic projection on a pair of glasses) 1303 for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

### Billing Method for New Movie

A method performed by one or more processing devices, comprising presenting media content via an audio/visual display to a purchaser; presenting to the purchaser, at a point during presentation of the media content combined with a template option to process that media content; receiving, from the purchaser, information for purchasing the media content for a recipient; issuing, to the recipient, a purchase confirm number and storing the purchase media in the user's account. A method, wherein requesting payment for the media content combine with the template from the purchaser comprises requesting payment for the cost of the media content combined with the template prior to issuing the purchase confirmation number to the recipient; and requesting payment. A method, further comprising: identifying the jurisdiction based on information provided by the purchaser of the media content combined with the customized template; obtaining a tax rate for the jurisdiction; and calculating an amount of the tax based on a tax rate for the jurisdiction and the cost of the media content combine with the template, if any tax is due. The one or more storage devices, wherein the instructions are executable to perform operations comprising: receiving payment for the media content combined with the template to process the media content with user takes from the purchaser. A method to provide payment for the new content created by processing the media content together with the user takes, using the instructions from the template, combined with user inputs on how to process the user takes, and then streaming the new video to end users for a pay per view fee. A method of combining the new combined video together with advertising and tracking rights holders by adding in metadata to the video and data to the records in the database of the original content, template creator and the new composite video, and then the split of advertising revenue between the original content own, the new user takes, and the template creator. The one or more storage devices, wherein the instructions are executable to perform operations comprising: combining the original media content, user takes and user inputs, using the instructions of the template, to create a new combined video and then adding advertising images or video to the composite and tracking the split of advertising revenue between the original content own, the new user takes, and the template creator.

### Face Detection, Face Swapping, Head Swapping and Background Subtraction

The preferred embodiment of the current invention includes an external function or API to detect faces and save or export the coordinate points. FIG. 20 and FIG. 21—The face detection function can be used to determine the number of unique persons in the video clip(s), the coordinate boundaries of each face, including X & Y coordinates of the upper left corners of the box around their face, W width and H height dimensions of the box around each of the following: face perimeter, right eye, left eye, nose, mouth, head, and other dimensions and coordinate points, including eyebrows, jaw lines, eyes open or closed, side to side angle of gaze, up and down angle of gaze, role of head, tilt of head, side-to-side tilt of head. The preferred embodiment of the current invention also includes an external function to isolate the background, subtract out the background, turning the background to a green screen or alpha channel for further processing. The present invention allows for the Information acquired via the facial detection system and can export the coordinate points of each facial feature to a text files or list variables or held in active ram memory as temporary variables, on a frame-by-frame basis. Capturing the coordinate dimensions and storing the information will allow for the rapid composting of head swaps and face swaps over stored template videos. The face detection system or service API can also be used to determine unique persons in the video clip(s), their identities or names and other related information, such as movie information, rights holders information, if available locally on the device or via the Internet for inclusion of the parties in credits screen. The face detection information can also be used to determine copy right violations for any video clips added into the computer systems that have been flagged by the copy right holders as unauthorized used of materials.

### Voice Detection, Audio Processing

The preferred embodiment of the current invention includes an external function or API to detect voices to allow for voice commands, such as “Action” or “Cut” to start and stop video recording, respectively. The voice system, which includes a device with a mic for detecting audio and a capture card for recording audio into a usable electrical signal, can also allow for navigation through the APP or allow for the creation of voice-to-text notes. The voice detection, in the preferred embodiment can also be used to auto sync the User Takes with the original source video and audio. For example, if a User records “I'll be back” from the Terminator® movie to do a voice over of the famous scene, the preferred embodiment of the present invention will detected the voice and automatically sync the voice and cut any leading or trailing recording time. The voice detection system or service API can also be used to determine and identify unique persons in the video clip(s), their identities or names and other related information such as movie information, rights holder information, if available locally on the device or via the Internet for inclusion of the parties in credits screen or any other portion of the finalized composition. The voice identification information can also be used to for detection of copy right violations for any audio or video clips added into the computer systems and communications network that have been flagged by the copy right holders as unauthorized used of materials.

### Speech to Text

The Speech-To-Text system, which includes a device with a mic for detecting audio and a capture card for recording audio into a usable electrical signal, which may be paired with a service API that can be used to convert the spoken word portions of a recorded audio track of a video clip or the audio track of an audio recording into written text where possible for the purposes of automatically adding notes, messages between users, language conversion, or subtitles, closed-captioning or meta-data to a video clip or the final composition. The Speech-To-Text API can also be used to for detection of copy right violations for any audio or video clips added into the systems that have been flagged by the copy right holders as unauthorized used of materials.

### Text to Speech

The Text-To-Speech system, which includes a device with a mic for detecting audio and a capture card for recording audio into a usable electrical signal, that can be paired with a service API that can be used to convert the written word portions of typed notes and Cue Card Lines of a given video or audio into speech for the purposes of automatically adding notes, messages between users, language translation, accessibility for illiterate or visually impaired or for the adding of subtitles, closed-captioning or metadata to a video clip or the final composition.

### Language Translation System

The language translation system or service API can be used for the purposes of automatically converting text data, such as Cue Card Lines, “How To” videos and help instructions, or messengering or comments input by the user, or titles and credits, into another language for localization or customizing the app when sharing over worldwide social networks or in combination with Speech-To-Text and Text-To-Speech to provide visual or audible translations of content. The language translation system can also convert audio tracks within a video stored in the database system to any language in the translation API to allow users to play scenes created in foreign languages that have not yet been converted to another language or the foreign language version has not yet been uploaded into the database of the app.

### Digital Circuitry

Various implementations of the computer systems, processes and methods described herein can be realized in digital electronic circuitry FIG. 15, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor 1507, which may be special or general purpose, coupled to receive data 1508 and instructions from, and to transmit data 1510 and instructions to, a storage system 102, at least one input device 105, and at least one output device 106 and 1311, with a display device 1310, and a recording device 1305.

### Scope of Invention

The implementation of the preferred embodiment has been described herein. However, it is understood that modifications may be made without departing from the spirit and scope of the invention describe herein. The diagrams, layouts, database structure and tables, process and method flow charts, equipment hardware diagrams, electronic circuits and hardware layouts, methods, machine instructions and logic flows depicted in the Figures herein do not require the particular order shown, or sequential order, to achieve desirable results. Additional steps may be added, or steps may be subtracted, from the described steps, processes and methods, and other computer components and equipment hardware may be added to, or removed from, the described computer systems. As a result, other implementations are within the scope of the invention described herein. Elements may be combined into one or more individual elements to perform the functions described herein. Elements of different implementations described herein may be combined to form other implementations not specifically set forth above or may be left out of the processes, methods or computer programs, user displays, user decisions, etc. described herein without adversely affecting their operation. A number of other implementations not specifically described herein are also within the scope of this invention. All or part of the computer systems, processes and methods described herein may be implemented as a computer hardware and computer program product that includes instructions that are stored on one or more non-transitory machine-readable storage devices, and that are executable on one or more processing devices. All or part of the computer systems, processes and methods described herein may be implemented as a computer apparatus, method, or electronic computer system that may include one or more processing devices and memory devices to store executable instructions to implement the programmed instructions. The details of the preferred embodiment of one or more implementations are set forth herein. Other features, objects, and advantages will be apparent from the description and drawings, as well as the apparatus, methods and processes described herein. It is clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive and not limited to the foregoing description or embodiments.

### ELEMENT LIST

### Element List:

101—Cloud Servers
102—Save to cloud hard drives
103—Internet
104—User 1 with Device
105—User 2 with Device
106—General Public with Device
201—Open Software Application on Phone
202—Decision—View videos stored on database
203—Cloud Service
204—Database
205—Cloud Storage
206—Begin Loop
207—Display
208—Decision
209—User Message
210—Predefined Process
211—Display
212—Database
213—Display
214—End Loop
215—Display
216—Cloud
217—Database
301—Button to open Navigator Menu
302—Button to search music videos to screen test and mash up
303—Button to search movies & movie clips to screen test and mash up
304—Button to search television and sports clips to screen test and mash up
305—Button to navigate to Edit Room
306—Navigator Menu
307—Button to open Help Popover (3C—308)
308—Navigation Popup Menu for How To Screen Test
401—Browse Videos—Search box
402—Browse Clips—Button to show favorites
403—Browse Clips—Button to star favorites
404—Browse Clips—Click of video to play
405—Browse Videos—Swipe to left, layout to view videos available to play for this video
406—Browse Videos—Button to select clip and stage it in a editing room
407—Browse Videos—Show information on a video
501—Button to selected current edit room.
502—Text fields to allow users to add titles and notes to the edit room
503—Scene button to allow users to navigate to Browse Video Clips layout
504—Button image of selected video clip to play.
505—Button to navigate to previous edit room
506—Button to select user take for a line
507—Button to navigate to next edit room
508—Button to send rendered video to the screen test portal
509—Button image that plays the rendered video
510—Scroll bar to scroll up and down edit rooms
511—Button to navigate to Action layout to record user takes for selected line to play
512—Button to pop up cue card of actor lines to play for selected line
513—Drop down menu to select roles and lines to play for selected video
514—Button to play the portion of scene and selected line to play for rehearsal
515—Button to quick record a user take
516—Button to play back selected user take
517—Button to select audio only for the selected scene to play
518—Button to bring up actors sharing this edit room
519—Button to manage actors in user's actor circle
520—Button to render scene with user take
521—Button to lock edit room to prevent it from being deleted
522—Button turns red when edit room is shared with other actors in user's actor's circle
523—Status bar of “render in progress”
524—Pop up menu of actors in user's actor's circle to share edit room
525—List of actors sharing current edit room
601—User recording name e.g. Take 1 Line 1 Role Sam
602—Actor name
603—Text box for notes about user recorded take
604—Box to select a take to render
605—Button to select audio dubbing and video settings
606—Button to delete take
607—Refresh button to load image place saver for take
608—Button to use front or rear camera (for mobile devices with dual cameras)
609—Button to activate the camera to start recording
610—Button to play the take
611—Button to open the settings window
612—Button to navigate back to edit room
613—Volume setting to increase or decrease volume for user recorded take
614—Pop up menu for user to select audio and video settings
701—Search box to search for actors
702—Headshot for actor profile
703—Button to navigate to prior actor
704—Button to select actor
705—Button to navigate to next actor
706—Button to view user reel
707—Button to view user acting photos
708—Button to view user acting skills
709—Button to view user acting profile
710—User reel button image to play video
711—User reel scroll bar to search for videos
712—Mash up videos for all users sharing videos with the public
713—Mash up scroll bar to search for videos
714—Button image to play original video clip
715—Button image to play user recorded take
716—Button image to play user mash up video
801—Text box for template name
802—Text box for template track number
803—Button to input description of template
804—Button to select introduction video or image to the final match up render
805—Button to give instructions to process user recorded takes by defining roles and lines for each role
806—Button to add clips to process
807—Button to add a clap board transition image or video in between the original video and the user take screen test
808—Button to add and advertisement from selected sponsors to the end of each video
809—Button to add processing steps to the template
810—Container field strip to add sample takes or clips when the clips button is selected and then select each take to then add settings for each select take or clip
811—Button to add image processing trim settings to the clip or take
812—Button to add image processing crop settings to the clip or take
813—Button to add image processing zoom settings to the clip or take
814—Button to add image processing position settings to the clip or take
815—Button to add image processing color settings to the clip or take
816—Button to add image processing border settings to the clip or take
817—Button to add image processing palette settings to the clip or take
818—Button to add image processing crop settings to the clip or take
901—Create a template from the detailed layout
902—Step Number
903—Select step from drop down menu
904—Select Line & Role to process
905—Select audio and video setting to process
906—Information on the template
907—Detailed code instructions generated from the template
908—Detailed code instructions generated from the step selected
909—Detailed code instructions generated from the template with line breaks
910—Template files to export to temporary edit room folder for processing
911—Set up roles to play with cue card dialog and clip setting or video sub-clips to aid users in practicing their lines
912—List of drop down steps pre programmed when user selects FIG. 9A 903.
913—List of drop down audio and video settings to process when user selects FIG. 9A 905.
1001—Preferred database structure
1101—Create template from a series of individual image processing computer instructions
1102—Cloud computing, including a server, processor, and digital storage
1103—Database stored on the cloud storage
1104—Display monitor for programming
1105—Input of template data by video editor/programmer creating new template
1106—Input assets to process, including images, videos and audio files
1107—Input lines and roles to play for video
1108—Input video clips for each line (optional) to aid users in rehearsals of parts
1109—Begin selection process of steps to add to the template to process user takes
1110—Add predefined step to process interim image files
1111—End loop after all steps have been added to process the steps necessary for all interim image processes
1112—Save the template
1113—Decision to test the template
1114—No testing, exit template creator layout
1115—Test the template, begin test loop
1116—Loop through exporting all template assets to the editing room folder
1117—End loop
1118—Begin loop
1119—Export takes to editing room folder
1120—End loop
1121—Execute series of predefined process steps to render video
1122—Display rendered video on monitor
1123—Template creator decision, does the template work, yes, exit, no, adjust the steps and repeat the test
1201—Create template by integrating with full pre-created project file in external video editor
1202—Cloud computing, including a server, processor, and digital storage
1203—Database stored on the cloud storage
1204—Display monitor for programming
1205—Input of template data by video editor/programmer creating new template
1206—Input video project file
1207—Input video project file assets
1208—Input lines and roles to play for video
1209—Input video clips for each line (optional) to aid users in rehearsals of parts
1210—Add predefined step to process project file with new user takes
1211—Save the template
1212—Decision to test the template
1213—No testing, exit template creator layout
1214—Test the template, begin test loop
1215—Loop through exporting all template assets to the editing room folder
1216—End Loop
1217—Begin Loop
1218—Export takes to editing room folder
1219—End Loop
1220—Execute predefined process steps to render video with project file from external video editor
1221—Display rendered video on monitor
1222—Template creator decision, does the template work, yes, exit, no, adjust the steps and repeat the test
1301—User wants to create a mash up video and invites actors in her circle
1302—User selects a line to play and records performance with a mobile phone with a video and audio recording device
1303—User selects a line to play and records performance with a video and audio recording device mounted in eye wear
1304—User select a line to play and records performance with a video and audio recording device, including tablets, desk top and lap tops
1305—User select a line to play and records performance with a recording device and a selfie stick
1306—User select a line to play with a recording device and a selfie stick
1307—User select a line to play and is recorded by a friend with a mobile video recording device
1308—User/Director selects with takes to use in the final video mash up and sends those video via a computer device
1309—User send instructions to process video on cloud server via the internet
1310—User selects to share video mash up with private user group or with the public via television, such as an Apple TV channel or YouTube channel
1311—User selects to share video mash up with private user group or with the public via internet, such as YouTube channel
1401—Rights holder of video clips and movies for sale to mash up
1402—Rights holder of template created by video editor and movies for sales to mash up
1403—User buys video clips or movie to customize
1404—User invites other actors to play scenes with him/her
1405—User customizes video
1406—Rights holders of new video
1501—Lens
1502—Sensor array
1503—Audio input mic
1504—Sound card
1505—Video display
1506—Audio speakers
1507—Microprocessor
1508—Data serializer
1509—Control
1510—Wireless communications card
1511—User interface and programming console
1512—Video display
1513—Audio speakers
1514—Microprocessor
1515—Data serializer
1516—Control
1517—Internet transmission
1518—Microprocessor with data serializer
1519—Pattern recognition system
1520—Image processor
1521—Data storage
1601—Article of manufacture on a mobile device
1602—Article of manufacture on a tablet device
1603—Article of manufacture on a server computer
1604—Article of manufacture on a cloud computer
1605—Article of manufacture on a CD or DVD
1606—Article of manufacture on a desk top computer
1607—Article of manufacture on a laptop computer
1608—Article of manufacture on a storage device
1701—Scripts to process while opening and closing the application, including loading any external functions or plug-ins, setting variables, setting user preferences such as language or last saved configurations, saving all data prior to exiting
1702—Scripts to process when users press a button through the application, such as play videos, star scenes, load videos and templates, save takes, delete takes, search
1703—Scripts to process for the editing room layout, including navigation between editing room records, locking records, playing videos, recording videos
1704—Scripts to process when the user selects a video template to head swap or face swap
1705—Scripts to process for the action layout, including recording a new take, deleting a take, selecting a take to render, editing settings for a take
1801—Scripts to process when the user selects to preview a user take
1802—Scripts to process when the user selects render a mash up video with selected user takes
1803—Scripts to process locally when user selects to render a mash up
1804—Scripts to process on server PSOS (Perform Script On Server) when the user selects to render mash up
1805—Scripts to process in the video library clip template creator
1806—Scripts to process in the actor portal, including play video mash ups, select actor circles and render mash ups
1807—Scripts to process when the user selected a navigation button
1808—Scripts to process when the user selects a button on the bottom menus
1809—Scripts to process when the user selects on the top menus
1810—Scripts to process that are miscellaneous and not previously mentioned above
1901—User actives the app on a mobile device or computer
1902—User navigates to actor reel layout to create a mash up
1903—User selects settings to include original clips
1904—Yes—data saved in user settings
1905—No—data saved in user settings
1906—Manual input user to select which videos to combine
1907—A schematic of a data saved in user settings
1908—Manual input user to select which order to play video
1908—Data saved in user settings
1910—Decision render reel/multivideo mash up
1911—Yes—process render
1912—Process render instructions with user settings
1913—Database of original clips
1914—Database user access to view stored mash ups/screen tests
1915—Display processing render status bar on user device
1916—Send user a message when render is complete
1917—Display render image when complete to play render when selected
1918—Exit the layout
2001—A user selects a scene to play and head swap themselves into the original scene
2002—User records a take, which is run through various processes to isolate the users head from the background
2003—User renders the final mash up video where the user's head is swapped into the original video together with the user audio dub settings while the rest of the scene remains the same
2004—User starts the process by opening the app on a mobile device, with a lens, a mic and video and audio capture cards
2005—Decision—user reviews and selects a scene to play
2006—Database access—user then accesses the database on a cloud server or scenes previously purchased or downloaded to the user device
2007—Data storage access the app database accesses videos in storage on the cloud servers or on the user's local device
2008—Manual input—user then records one or more performance takes on the scene, and if there is more than one line, multiple takes may be necessary to render the full scene
2009—Manual input—user then selects which take(s) to render
2010—Pre-defined process—user renders head swap using predefined template instructions and the head swap script steps
2011—Process—video is passed through a background subtractions filter. a simple background subtraction filter may include an additional input from the user of a still image of the background, or the user can step out of a frame and capture the Background to subtract out of the user video take
2012—Process decompile both videos (take(s) and original clip(s) into individual frames and audio tracks
2013—Process—detect face for each frame
2014—Process—calculate head dimensions based on ratios
2015—Direct access data—create a temporary array of values, frame-by-frame, including the x, y, width and height coordinate for the outer boundary of the detected head
2016—Process—crop head from user take and overlay onto original clip on a frame-by-frame basis
2017—Process—recompile mash up video of images with head swap overlays with audio tracks, per user dub settings, including metadata to track digital rights
2018—Display—show the head swap video on user device if mash up was rendered locally on user device
2019—Send video stream to user device if mash up was rendered remotely on server
2020—Access database update digital rights with new actor information
2021—Save render to server storage device or local user device and add metadata to final composite video
2101—A user selects a scene to play and face swap themselves into the original scene
2102—user records a take, which is run through various processes to isolate the user's face
2103—User renders the final mash up video where the user's face is swapped into the original video, together with the user audio dub settings, while the rest of the scene remains the same
2104—User starts the process by opening the app on a mobile device, with a lens, a mic and video and audio capture cards
2105—Decision—user reviews and selects a scene to play database access—user then accesses the database on a cloud server or scenes
2106—Previously purchased or downloaded to the user device
2107—Data storage access—the app database accesses videos in storage on the cloud servers or on the user's local device
2108—Manual input—user then records one or more performance takes on the scene, and if there is more than one line, multiple takes may be necessary to render the full scene
2109—Manual input—user then selects which take(s) to render
2110—Predefined process—user renders face swap using predefined template instructions and the face swap script steps
2111—Process—decompile both videos (take(s) and original clip(s) into individual frames and audio tracks
2112—Process—detect face for each frame
2113—Process—calculate face dimensions, including dimensions of face parts such as eyes and mouth
2114—Direct access data—create a temporary array of values, frame-by-frame, including the x, y, width and height coordinate for the outer boundary of the detected face, including face parts
2115—Process—crop face from user take and overlay onto original clip on a frame-by-frame basis
2116—Process—recompile mash up video of images with face swap overlays with audio tracks, per user dub settings, including metadata to track digital rights
2117—Display—show the face swap video on user device if mash up was rendered locally on user device
2118—Send video stream to user device if mash up was rendered remotely on server
2119—Access database update digital rights with new actor information
2120—Save render to server storage device or local user device and add metadata to final composite video

I claim:

1. A method of inserting at least one user into a digital video work, comprising the steps of:
selecting an original video work from a library of original video works;
viewing said original video work selected from said library;
selecting a scene from said original video work;
recording one or more users' takes based on said scene;
selecting from said one or more takes a preferred take;
creating a mash-up of said preferred take and said scene;
saving said mash-up to storage in order to form a clip; and
publishing said clip on one or more publishing services.

2. The method of inserting at least one user into a digital video work of claim 1, wherein said digital video work can be selected from the group consisting of movie clips, full-length movies, animations, music videos, commercials, videos of sporting events, other videos, audio-only clips, and other digital medium.

3. The method of inserting at least one user into a digital video work of claim 1, whereby selecting an original work from a library comprises accessing a remote storage database upon which said library is stored.

4. The method of inserting at least one user into a digital video work of claim 1, whereby viewing said original video work occurs on a portable viewing device.

5. The method of inserting at least one user into a digital video work of claim 1, whereby recording one or more users takes involves recording a digital video and audio lines based on said selected scene.

6. The method of inserting at least one user into a digital video work of claim 1, whereby creating a mash-up of said preferred take and said scene involves computer coded instructions.

7. The method of inserting at least one user into a digital video work of claim 1, further comprising the steps of combining one or more mash-ups to create a customized video.

8. A system for preparing a custom video work clip based on an original video work, comprising;
a computing system selected from the group consisting of mobile devices, tablets, laptops, game consoles, augmented reality headsets, desktops, wherein the computing system is configured to execute coded instructions capable of:
selecting an original video work from a library of original video works;
viewing said original video work selected from said library;
selecting a scene from said original video work;
recording one or more users' takes based on said scene;
selecting from said one or more takes a preferred take;
creating a mash-up of said preferred take and said scene;
saving said mash-up to storage in order to form a clip; and
publishing said clip on one or more publishing services;
one or more remote storage devices in remote connection with said computing system;
one or more processors for processing said original video work and creating said customized video work;
a graphical user interface (GUI) for allowing one or more users to interact with said system, wherein said GUI includes digital button for searching video works, digital button for customized video work creation, and digital button for take recording; and
a display attached to said computing system.

9. The system of claim 8, wherein selecting said digital video work based on said coded instructions involves selecting from the group consisting of movie clips, full-length movies, animations, music videos, commercials, videos of sporting events, and other videos.

10. The system for preparing a custom video work clip based on an original video work of claim 8, wherein recording one or more users takes based on said coded instructions involves recording a digital video and audio lines based on said selected scene.

11. The system for preparing a custom video work clip based on an original video work of claim 8, wherein creating a mash-up of said preferred take and said scene involves computer coded instructions.

12. The system for preparing a custom video work clip based on an original video work of claim 8, further comprising coded instructions for combining one or more mash-ups to create a customized video.

13. The system for preparing a custom video work clip based on an original video work of claim 8, further comprising coded instructions for combining different scenes for said different original video work by selecting said scenes, organizing said scenes, and creating new scene sequences to result in creating new mashups.

14. The system for preparing a custom video work clip based on an original video work of claim 8, further comprising coded instructions for combining identifiers selected from logos, ads, signals, and trademarks and rendering said combined identifiers into said mash-up.

15. A method of searching and tracking for digital rights management in an original video work and a mash-up clip, comprising the steps of:
creating a mash-up clip involving the steps of
selecting an original video work from a library of original video works;
viewing said original video work selected from said library;
selecting a scene from said original video work;
recording one or more users' takes based on said scene;
selecting from said one or more takes a preferred take;
creating a mash-up of said preferred take and said scene;
saving said mash-up to storage in order to form a clip;
publishing said clip on one or more publishing services; and
utilizing a hierarchical database structure incorporated within a communication network of data processing devices such that metadata can be communicated between said original video work and such mash-up clip.

16. A method of compiling and editing computer coded instructions using templates that compile a sequence of computer commands based on a users inputs to include one or more user takes, comprising the steps of:
compiling and executing coded instructions on a processor, said processor stored remotely or locally in order to process said user takes;
integrating one or more mobile devices selected from the group consisting of mobile devices, laptops, tablets, game consoles, augmented reality headsets, and personal computer devices, with video works stored in a remote database, said mobile devices linking with said computer coded instructions templates; and
creating mash-up from said user takes and original video works obtained from said database.

17. A method to create and manage computer coded instruction templates and original video works, and integrating said template and original video work with one or more user takes, comprising the steps of:
creating a template using a digital editor;
formatting said template into a video work form selected from the group consisting of picture-in-picture, side-by-side, head swapping between a user and an actor in said original video work, face swapping between a user and an actor in said original video work, and other sequence;
setting up said character roles to play in said template;
loading up scenes from one or more original video works;
configuring names of said scenes with names of a user's takes;
processing said template with said user takes to create a mash-up video work; and
inserting metadata into video file from a data structure of a computer system and interconnected devices having lens and video and audio capture cards, and a set of image processing instructions.

18. A portable digital storage device prepared by a process comprising the steps of:
a first plurality of binary values for receiving a transmission and storing said transmission in a first data format;
a second plurality of binary values for transforming the first data format to a second data format;
a third plurality of binary values for scanning the second data format to determine a recipient of the transmission out of a plurality of potential recipients in a communication network;
in the event no direct recipient is determined, identifying a default recipient or a recipient by said third plurality of binary values as being the most likely intended recipient of the transmission is set to be the recipient;
a fourth plurality of binary value for electrically routing the transmission to a recipient chosen from the plurality of potential recipients by the scanning performed by the third plurality of binary values; and
a fifth plurality of binary values for storing log data to keep a history of past electronic routings of data.
